(19) United States
(12) Patent Application Publication
(10) Pub. No.: US 2009/0158162 A1
(43) Pub. Date: Jun. 18, 2009

(54) DISPLAY SYSTEM

(76) Inventor: Daiji IMAI, Kyoto-shi (JP)

Correspondence Address: NIXON & VANDERHYE, P.C., 901 NORTH GLEBE ROAD, 11TH FLOOR, ARLINGTON, VA, 22203, US

(21) Appl. No.: 12/331,944

(22) Filed: Dec. 10, 2008

(30) Foreign Application Priority Data
Dec. 12, 2007 (JP) 2007-321133

(51) Int. Cl. G06F 3/048

(52) U.S. Cl. 715/734

(57) ABSTRACT

A display system is for displaying a degree of popularity of a plurality of selection objects like an electronic program guide displaying system, for example, and includes a plurality of user terminals. Each of the plurality of user terminals is connected to a server via a network, for example. Each user terminal displays a plurality of program information in a matrix manner, and accepts an operation to select desired program information. The server calculates a degree of popularity of each program information on the basis of the results of the selections by the respective user terminals, and transmits the degree of popularity to each user terminal. On the side of the user terminal, a display manner of each program information is changed on the basis of the degree of popularity. For example, the degree of popularity is calculated so as to be classified into plurality of levels, and as a display manner of each program information, the color density and the height are changed depending on the level of the degree of popularity.

### CROSS REFERENCE OF RELATED APPLICATION

The disclosure of Japanese Patent Application No. 2007-321133 is incorporated herein by reference.

### BACKGROUND OF THE INVENTION

1. Field of the Invention

The present invention relates to a display system, and more particularly, to a display system capable of displaying a plurality of selection objects. Furthermore, this invention relates to an electronic program guide displaying system, and in particular, to an electronic program guide displaying system including plurality of user terminals each having a display on which a plurality of program information are displayed in a matrix manner by taking one axis as a time axis and the other axis as a broadcast station axis and a server performing data communication with the plurality of user terminals via a network.

2. Description of the Related Art

Conventionally, in a system of displaying an electronic program guide of TV programs, etc., such as display an evaluation and an order of popularity of each program is known.

For example, a Patent Document 1 (WO2005/027512 [H04N 7/173, H04N 5/445, G06F 17/30]) discloses an apparatus for inputting an evaluation of a content on an electronic program guide. In the apparatus, a user inputs an evaluation (likes or dislikes) with respect to a content included in a list of content (electronic program guide, for example) displayed on the screen. The program evaluated by the user is applied with an evaluation mark, that is, a character “Y” indicating “likes” and a character “N” indicating “dislikes” (see FIG. 3A-FIG. 3C in the Patent Document 1).

Furthermore, a Patent Document 2 (Japanese Patent Application Laid-Open No. 2006-270668 [H04N 7/173, H04N 5/44]) discloses that in an apparatus to reserve a program like a television broadcasting, etc. at the designated hour via a communication network, a ranking list of reservation indicating an order of popularity of a program is obtained from the server so as to be displayed. In the ranking list of reservation, items of the program are listed from the program that the most persons program to reserve like top ten in ascending order (see FIG. 4 in the Patent Document 2).

However, in the above-described Patent Document 1, the evaluation displayed on the electronic program guide is an evaluation according to a user's private preference, and therefore, it is impossible to know a degree of popularity based on evaluations of a number of users. Furthermore, in the Patent Document 2, by displaying a ranking list of reservation, it is possible to know the ranking of the popularity of the programs, but the top ten programs are merely displayed on the list, and therefore, a problem that it is difficult to intuitively grasp a degree of popularity of programs on the electronic program guide arises. For example, it is impossible to know to what extent the program on the list are popular in comparison with other programs in the same time slot, and moreover, even if the program is a program which the user is interested in, if it is fallen from the list, it is impossible for the user to know the degree of popularity.

### SUMMARY OF THE INVENTION

Therefore, it is a primary object of the present invention to provide a novel display system, a novel electronic program guide displaying system, a novel user terminal utilized in the electronic program guide system, a novel storage medium storing programs of the user terminal, a novel server employed in the electronic program guide system, and a novel storage medium storing programs of the server.

Another object of the present invention is to provide a display system capable of intuitively grasping a degree of popularity of a selection object.

Still another object of the present invention is to provide an electronic program guide displaying system, a user terminal utilized in the electronic program guide system, a storage medium storing programs of the user terminal, a server utilized in the electronic program guide system, and a storage medium storing programs of the server which are able to intuitively grasp a degree of popularity of a program.

The present invention employs following features in order to solve the above-described problems. It should be noted that reference numerals inside the parentheses and supplemental remarks show one example of a corresponding relationship with the embodiments described later for easy understanding of the present invention, and do not limit the present invention.

A first invention is an electronic program guide displaying system including a plurality of user terminals each having a display to display a plurality of program information in a matrix manner by regarding one axis as a time axis and the other axis as a broadcast station axis, and a server to perform a data communication with the plurality of user terminals via a network. Each of the user terminals comprises an accepting means, a first transmitting means, a first receiving means, and a display manner changing means. The accepting means accepts a selecting operation to select desired program information out of the plurality of program information. The first transmitting means transmits a result of the selecting operation accepted by the accepting means to the server. The first receiving means receives degree of popularity data of each of the program information from the server. The display manner changing means changes a display manner of each program information displayed in a matrix on the basis of the degree of popularity data. The server comprises a second receiving means, a degree of popularity calculating means, and a second transmitting means. The second receiving means receives a result of the selecting operation from each of the user terminals. The degree of popularity calculating means calculates degree of popularity data indicating a degree of popularity of each of the plurality of program information on the basis of the result of the selecting operation. The second transmitting means transmits the degree of popularity data calculated by the degree of popularity calculating means to each of the user terminals.

In the first invention, an electronic program guide displaying system (100) includes a plurality of user terminals (10, 12) and a server (102), and each user terminal can transmits and receives data with the server (102) via a network (104). On a display (34) of each user terminal, an electronic program guide is displayed, that is, a plurality of program information is displayed so as to be arranged in a matrix manner. In each user terminal, the user can select desired program information, and the selecting operation is accepted by an accepting means (22, 40, S11-S23). For example, the user selects a program by making detailed information of the program display, marking the program, and so forth. A first transmitting means (40, 42a, 50, S25-S29) transmits the result of the selecting operation to the server. For example, the result of a selecting operation to be transmitted may include identification information and regional information of the user terminal, the number of users being brought into correspondence with the identification information of the selected program, private information of the user, and information indicating whether or not the detailed information is displayed. A second receiving means (S65-S67) of the server receives the result of the selecting operation transmitted from each of the user terminals. Since the results of the selecting operations are received from the plurality of user terminals, the server can calculate by totalizing how strong each program information is interested, that is, how popular each program information is. That is, a degree of popularity calculating means (102, S69-S77) calculates degree of popularity data of each program information on the basis of the result of the selecting operation. If the degree of popularity data is transmitted from the server to each of the user terminals, each user terminal can obtain a degree of popularity of each program information. Accordingly, a second transmitting means (S61-S63) transmits degree of popularity data to each of the user terminals. In the user terminal, a first receiving means (40, 42a, 50, S3-S5) receives the degree of popularity data. Then, a display manner changing means (40, 42b, S33-S43) changes a display manner of each program information on the basis of the degree of popularity data. Accordingly, in the electronic program guide, each program information is displayed in a display manner according to the degree of popularity.

According to the first invention, a degree of popularity of each program information is calculated on the basis of a selecting operation by the user, and the display manner of each program information displayed in a matrix is changed depending on the degree of popularity, so that each degree of popularity of the program can be represented by the display manner on the program guide. Thus, it is possible to allow the user to intuitively grasp a degree of popularity of each program.

A second invention is an electronic program guide displaying system according to the first invention, and the degree of popularity calculating means classifies the plurality of program information into a plurality of levels on the basis of the result of the selecting operation, and calculates the degree of popularity data indicating the level of each of the program information, and the display manner changing means changes each of the program information into a display manner set in advance for each level.

In the second invention, the degree of popularity calculating means (S77) calculates a degree of popularity classified into a plurality of levels or stages. The display manner corresponding to the level of the degree of popularity is set in advance, and the display manner changing means changes each of the program information into the display manner for each level. Thus, it is possible to display change in a display manner simply and intelligibly. For example, the display manner of each program information can be gradually changed in accordance with the level. Furthermore, it is possible for the user to grasp a level of the degree of popularity by the display manner.

Third and fourth inventions are electronic program guide displaying systems respectively dependent on the first and the second inventions, and the accepting means accepts at least one selecting operation out of a first selecting operation to set the desired program information to a first state and a second selecting operation to set the desired program information to a second state, and the degree of popularity calculating means calculates the degree of popularity data by applying different weights between the first selecting operation and the second selecting operation.

In the third and fourth inventions, the accepting means can accept two kinds of selecting operations of a first selecting operation and a second selecting operation. The program information selected by the first selecting operation is set to the first state, and the program information selected by the second selecting operation is set to the second state. For example, the first selecting operation is an operation of making the detailed information of the program display, and the program information selected by the first selecting operation is set to the first state that a detail flag indicating that the detailed information of the program is watched is turned on. Furthermore, the second selecting operation is an operation of marking a program as a program that the user wants to watch, and the selected program information selected by the second selecting operation is set to the second state that a total value of the users who mark the program and user IDs of the users who mark the program are recorded. If the first selecting operation and the second selecting operation which represent the difference in interest in the program are defined, the result of the selecting operation including information on the degree of interest by the user can be transmitted. In the server, the degree of popularity calculating means calculates a degree of popularity by applying different weights between the first selecting operation and the second selecting operation. For example, if the aforementioned selecting operations are defined, by applying a weight depending on the degree of interest by the user, it is possible to calculate the degree of popularity on which the degree of interest is reflected.

Thus, it is possible to calculate a degree of popularity obtained by applying a different weight depending on the kind of a selecting operation by the user. For example, in a case of a selecting operation such as the degree of interest in the program by the user can be identified depending on the kind of the selecting operation, it is possible to calculate a degree of popularity on which a degree of interest by the user is accurately reflected.

Fifth and sixth inventions are electronic program guide displaying systems respectively depending on the first and second inventions, and the display manner changing means changes a density of a display color of each of the program information on the basis of the degree of popularity data.

In the fifth and sixth inventions, since the density of color is changed depending on the degree of popularity as a display manner, it is possible to represent a degree of popularity of each of the program information according to a change in a color density. This makes it possible to visually grasp the degree of popularity of each program information.

Seventh and eighth inventions are electronic program guide displaying systems respectively according to the first and second inventions, and each of the user terminals displays the plurality of program information displayed in a matrix manner by a 3-D image, and the display manner changing means changes a height of each of the program information on the basis of the degree of popularity data.

In the seventh and eighth inventions, since a plurality of program information displayed in a matrix manner is displayed by a 3-D image, a height of each program information can be displayed in the program guide. Then, the height is changed depending on the degree of popularity as a display manner, and therefore, it is possible to represent the degree of popularity of each program information by the change in height. This makes it possible to visually grasp the degree of popularity of each program information.

Ninth and tenth inventions are electronic program guide displaying systems respectively according to the first and second inventions, and each of the user terminal further comprises a private information inputting means for inputting private information of each user, the first transmitting means transmits the private information in addition to the result of the selecting operation to the server, the degree of popularity calculating means calculates the degree of popularity data indicating a degree of popularity of each of the program information for each kind of the private information on the basis of the result of the selecting operation and the private information, and the display manner changing means changes the display manner of each of the program information on the basis of the degree of popularity data corresponding to the selected kind.

In the ninth and tenth inventions, private information input by each of the users is fetched by a private information inputting means (22, 40, S1). For example, the private information is a year of birth and a gender of the user. The private information is transmitted to the server by the first transmitting means. In the server, the degree of popularity calculating means calculates a degree of popularity for each kind of the private information on the basis of the private information. For example, it is possible to calculate the degree of popularity of the user on an age-basis, on a gender-basis or on a generation-basis, etc. When such a degree of popularity is transmitted to each user terminal by the second transmitting means, in the user terminal, the display manner changing means changes the display manner depending on the degree of popularity for each selected kind. Since the degree of popularity for each kind of the private information can be displayed in the program guide, it is possible to grasp a trend of a degree of popularity of a program for each kind of the private information. For example, it is possible to easily know the difference in the degree of popularity of a program between males and females, in a degree of popularity on an age-basis and a generation-basis.

Eleventh and twelfth inventions are electronic program guide displaying systems respectively according to the first and second inventions, and the degree of popularity calculating means compares the respective program information for each time slot with a predetermined range on the basis of the result of the selecting operation, and calculates the degree of popularity data indicating the degree of popularly of the respective program information in each time slot on the basis of the comparison result.

In the eleventh and twelfth inventions, the degree of popularity calculating means calculates a degree of popularity of each of the program information for each time slot. Accordingly, in the user terminal, the degree of popularity for each time slot can be displayed in the program guide, capable of grasping a trend of a degree of popularity of a program for each time slot. If the degree of popularity is calculated not for each time slot but for the entire time slots, the degree of popularity of a program at a prime time which relatively a number of users watch and listen to is generally apt to be high while programs at the other time slots, even if they are high in degree of popularity at these time slots, may be relatively low in comparison with the program at the prime time (the number of users is low) and may relatively be displayed in low. However, if the degree of popularity is calculated for each time slot, such a problem is solved, capable of accurately displaying a degree of popularity of a program for each time slot.

Thirteenth and fourteenth inventions are electronic program guide displaying systems respectively according to the first and second inventions, and the first transmitting means transmits regional information in addition to the result of the selecting operation to the server, the degree of popularity calculating means calculates the degree of popularity data indicating a degree of popularity of each of the program information for each region on the basis of the result of the selecting operation and the regional information, and the second transmitting means transmits the degree of popularity data corresponding to the regional information transmitted by the first transmitting means to each of the user terminals.

In the thirteenth and fourteenth inventions, the first transmitting means transmits regional information to the server. The regional information is identification information of a region where the user terminal is used. In the server, the degree of popularity calculating means calculates a degree of popularity of each program for each region on the basis of the regional information. When the degree of popularity corresponding to the regional information of the user terminal is transmitted to each of the user terminals by the second transmitting means, in the user terminal, the display manner changing means changes the display manner depending on the degree of popularity in the region. Accordingly, in the user terminal, it is possible to display a degree of popularity of the region in the program guide. This makes it possible to grasp a trend of the degree of popularity of a program for each region. For example, if the degree of popularity is calculated not for each region but for entire regions, there occurs problems that the degree of popularity of a major program broadcasted at all the regions generally is apt to be generally high, and a degree of popularity of a program which is broadcasted at a specific region but has a high degree of popularity in that region is apt to be generally displayed in low. However, if the degree of popularity is calculated for each region, such a problem is solved, and it is possible to more accurately display a degree of popularity of a program at each region.

A fifteenth invention is an electronic program guide displaying system to display a plurality of program information in a matrix manner by regarding one axis as a time axis and the other as a broadcast station axis, and comprises an accepting means, a degree of popularity calculating means, and a display manner changing means. The accepting means accepts a selecting operation to select desired program information out of the plurality of program information from a plurality of users. The degree of popularity calculating means calculates degree of popularity data indicating a degree of popularity of each of the plurality of program information on the basis of the result of the selecting operation accepted by the accepting means. The display manner changing means changes the display manner of each of the program information displayed in the matrix on the basis of the degree of popularity data calculated by the degree of popularity calculating means.

In the fifteenth invention, in an electronic program guide displaying system (100), a plurality of program information are displayed in a matrix manner, that is, an electronic program guide is displayed. An accepting means (11, 12, 22, S11-S23) accepts a selecting operation to select desired program information from a plurality of users. For example, if the electronic program guide displaying system includes a plurality of user terminals, each user terminal is provided with an accepting means to accept a selecting operation by each user. The degree of popularity calculating means (102, S69-S77, 12, 40, S121-S135) calculates a degree of popularity of each of the program information on the basis of the result of the accepted selecting operation. For example, if the electronic program guide displaying system includes a server and a plurality of user terminals, the degree of popularity calculating means may be provided to the server, a predetermined user terminal, or each user terminal. Alternatively, calculation of the degree of popularity may be performed by distributed processing by the plurality of user terminals, for example. The display manner changing means (12, 40, 42b, S33-S43) changes the display manner of each of the program information displayed in the matrix on the basis of the calculated degree of popularity. Accordingly, in the program guide, each of the program information is displayed in a display manner corresponding to the degree of popularity.

According to the fifteenth invention, similar to the above-described first invention, each degree of popularity of a program can be represented by the display manner on the program guide. This allows the user to intuitively grasp a degree of popularity of each program.

A sixteenth invention is a user terminal which is utilized in an electronic program guide display system, performs a data communication with a server via a network, and has a display displaying a plurality of program information in a matrix manner by regarding one axis as a time axis and the other axis as a broadcast station axis. The user terminal comprises an accepting means, a first transmitting means, a first receiving means, and a display manner changing means. The accepting means accepts a selecting operation to select desired program information from the plurality of program information. The first transmitting means transmits the result of the selecting operation accepted by the accepting means to the server. The first receiving means receives the degree of popularity data of each of the program information calculated on the basis of the result of the selecting operation from the server. The display manner changing means changes the display manner of each program information displayed in a matrix on the basis of the degree of popularity data.

The sixteenth invention is the user terminal applicable to the electronic program guide displaying system in the above-described first invention, and thus allows the user to intuitively grasp a degree of popularity of each program in the program guide similar to the first invention.

A seventeenth invention is a storage medium storing a program to be executed by a computer of a user terminal which is utilized in an electronic program guide display system, performs a data communication with a server via a network, and has a display displaying a plurality of program information in a matrix manner by regarding one axis as a time axis and the other axis as a broadcast station axis. The program causes the computer to execute an accepting step, a first transmitting step, a first receiving step, and a display manner changing step. The accepting step accepts a selecting operation to select desired program information from the plurality of program information. The first transmitting step transmits the result of the selecting operation accepted by the accepting step to the server. The first receiving step receives the degree of popularity data of each of the program information calculated on the basis of the result of the selecting operation from the server. The display manner changing step changes a display manner of each program information displayed in the matrix on the basis of the degree of popularity data.

The seventeenth invention is a storage medium storing a program of a user terminal applicable to the electronic program guide displaying system in the above-described first invention, and thus has an advantage similar to the first invention and the sixteenth invention.

An eighteenth invention is a server which is used in an electronic program guide displaying system, and performs a data communication via a network with a plurality of user terminals each having a display displaying a plurality of program information in a matrix manner by regarding one axis as a time axis and the other axis as a broadcast station axis. The server comprises a second receiving means, a degree of popularity calculating means, and a second transmitting means. The second receiving means receives from each of the user terminal the result of the selecting operation which is accepted by each of the user terminal and is for selecting desired program information out of the plurality of program information. The degree of popularity calculating means calculates degree of popularity data to change, on the basis of the result of the selecting operation, the display manner of each program information which indicates a degree of popularity of each of the plurality of program information and displayed in a matrix manner in each of the user terminal. The second transmitting means transmits the degree of popularity data calculated by the degree of popularity calculating means to each of the user terminal.

The eighteenth invention is the server applicable in the electronic program guide displaying system of the above-described first invention, and allows the user to intuitively grasp a degree of popularity of each program in the program guide similar to the first invention.

A nineteenth invention is a storage medium storing a program to be executed by a computer of a server which performs a data communication via a network with a plurality of user terminals which are used in an electronic program guide displaying system, each having a display displaying a plurality of program information in a matrix manner by regarding one axis as a time axis and the other axis as a broadcast station axis. The program causes the computer to execute a second receiving step, a degree of popularity calculating step, and a second transmitting step. The second receiving step receives from each of the user terminal the result of the selecting operation which is accepted by each of the user terminal and is for selecting desired program information out of the plurality of program information. The degree of popularity calculating step calculates degree of popularity data to change, on the basis of the result of the selecting operation, the display manner of each program information which indicates a degree of popularity of each of the plurality of program information and displayed in a matrix manner in each of the user terminal. The second transmitting step transmits the degree of popularity data calculated by the degree of popularity calculating step to each of the user terminal.

The nineteenth invention is a storage medium storing a program of the server applicable in the electronic program guide displaying system of the above-described first invention, and has an advantage similar to the first invention and the eighteenth invention.

A twentieth invention is a display system for displaying a plurality of selection objects, and comprises an accepting means, a degree of popularity calculating means, and a display manner changing means. The accepting means accepts a selecting operation to select a desired selection object out of the plurality of selection objects from a plurality of users. The degree of popularity calculating means calculates degree of popularity data indicating a degree of popularity of each of the plurality of selection objects on the basis of the result of the selecting operation accepted by the accepting means. The display manner changing means changes a display manner of each of the selection objects on the basis of the degree of popularity data calculated by the degree of popularity calculating means.

In the twentieth invention, in the display system (100), a plurality of selection objects are displayed. The selection object is a matter to be selected by the user, and may include a content such as a game software, a product, and program information of an electronic program guide, for example. An accepting means (10, 12, 22, S11-S23) accepts a selecting operation to select a desired selection object out of the plurality of selection objects from a plurality of users. If the display system includes a plurality of user terminals, each user terminal is provided with the accepting means to accept a selection operation from each user. A degree of popularity calculating means (102, S69-S77, 12, 40, S121-S135) calculates a degree of popularity of each selection object on the basis of the result of the accepted selecting operation. For example, if the display system includes a server and a plurality of user terminals, the degree of popularity calculating means may be provided to the server, the predetermined user terminal, the respective user terminals. Alternatively, by distributed processing by the plurality of user terminals, calculation of the degree of popularity may be performed. A display manner changing means (12, 40, 42b, S33-S43) changes a display manner of each of the selection objects depending on the calculated degree of popularity. Thus, each selection object is displayed in a manner corresponding to the degree of popularity.

According to the twentieth invention, a degree of popularity of each selection object can be represented by its display manner, and this allows the user to intuitively grasp a degree of popularity of each selection object.

According to the present invention, since the display manner of each selection object is changed depending on the degree of popularity, it is possible to realize a display system allowing for intuitive grasp of a degree of popularity of each selection object. In a case of the electronic program guide displaying system, the display manner of each program information displayed in a matrix is changed depending on the degree of popularity, so that the user can intuitively grasp a degree of popularity of each program on the program guide. Specifically, the user can easily grasp a trend as which time slot or broadcast station has a lot of popular programs.

The above described objects and other objects, features, aspects and advantages of the present invention will become more apparent from the following detailed description of the present invention when taken in conjunction with the accompanying drawings.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one example of a game system of the present invention;

FIG. 2 is a block diagram showing an electric configuration of the game system shown in FIG. 1;

FIG. 3 is an illustrative view showing an appearance of the controller shown in FIG. 1;

FIG. 4 is a block diagram showing an electric configuration of the controller shown in FIG. 3;

FIG. 5 is an illustrative view for roughly explaining a condition when a game is played by utilizing the controller shown in FIG. 1;

FIG. 6 is an illustrative view explaining view angels of the marker and the controller shown in FIG. 1;

FIG. 7 is an illustrative view showing one example of an imaged image including object images;

FIG. 8 is an illustrative view showing one example of an electronic program guide displaying system of the present invention;

FIG. 9 is an illustrative view showing one example of a memory map of the game apparatus shown in FIG. 1;

FIG. 10 is an illustrative view showing one example of the result information shown in FIG. 9;

FIG. 11 is an illustrative view showing one example of the display manner data shown in FIG. 9;

FIG. 12 is an illustrative view showing one example of a memory map of the distribution server shown in FIG. 8;

FIG. 13 is an illustrative view showing one example of a program guide in a normal state;

FIG. 14 is an illustrative view showing one example of the program guide in a normal state which is displayed by a 3-D image;

FIG. 15 is an illustrative view showing one example of a detailed screen of program information;

FIG. 16 is an illustrative view showing one example of the program guide in a state that a result of the program selection is displayed;

FIG. 17 is an illustrative view explaining a method of totalization result information;

FIG. 18 is an illustrative view for explaining a method of classifying a degree of popularity;

FIG. 19 is an illustrative view showing one example of degree of popularity data;

FIG. 20 is an illustrative view showing one example of the program guide in a state that a degree of popularity is displayed;

FIG. 21 is an illustrative view showing one example of a program guide with the degree of popularity displayed which is displayed in a 3-D image;

FIG. 22 is an illustrative view showing one example of a screen for setting a targeted range of the degree of popularity;

FIG. 23 is a flowchart showing a part of one example of an operation of a client;

FIG. 24 is a flowchart showing a part of a sequel to FIG. 23;

FIG. 25 is a flowchart showing another part of a sequel to FIG. 23;

FIG. 26 is a flowchart showing one example of an operation of the distribution server;

FIG. 27 is an illustrative view showing one example of an electronic program guide displaying system of another embodiment;

FIG. 28 is a flowchart showing one example of an operation of transmission/reception processing of the game apparatus of this another embodiment;

FIG. 29 is a flowchart showing one example of an operation of degree of popularity calculating processing; and

FIG. 30 is an illustrative view showing one example of a friend list screen for calculation of a degree of popularity in this another embodiment.

### DETAILED DESCRIPTION OF THE PREFERRED EMBODIMENTS

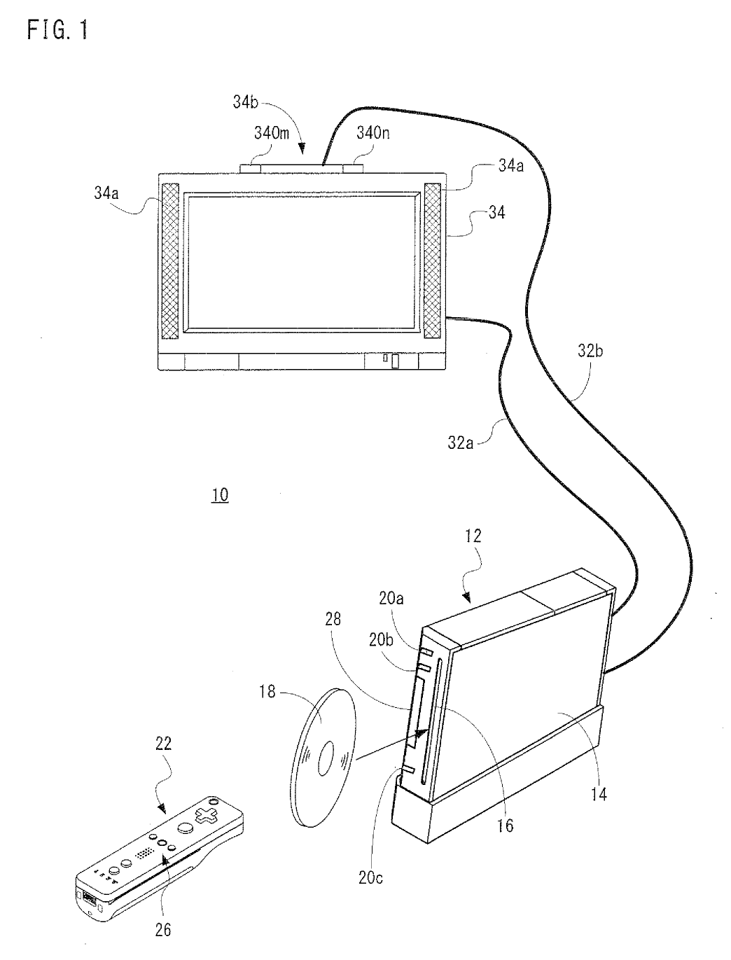

Referring to FIG. 1, a game system 10 of one embodiment of the present invention includes a video game apparatus (hereinafter, simply referred to as “game apparatus”) 12 and a controller 22. Although illustration is omitted, the game apparatus 12 of this embodiment is designed such that it can be connected to four controllers 22 at the maximum. Furthermore, the game apparatus 12 and the respective controllers 22 are connected by radio. The wireless communication is executed according to a Bluetooth (registered trademark) standard, for example, but may be executed by other standards such as infrared rays, a wireless LAN. Alternatively, they may be connected by wire.

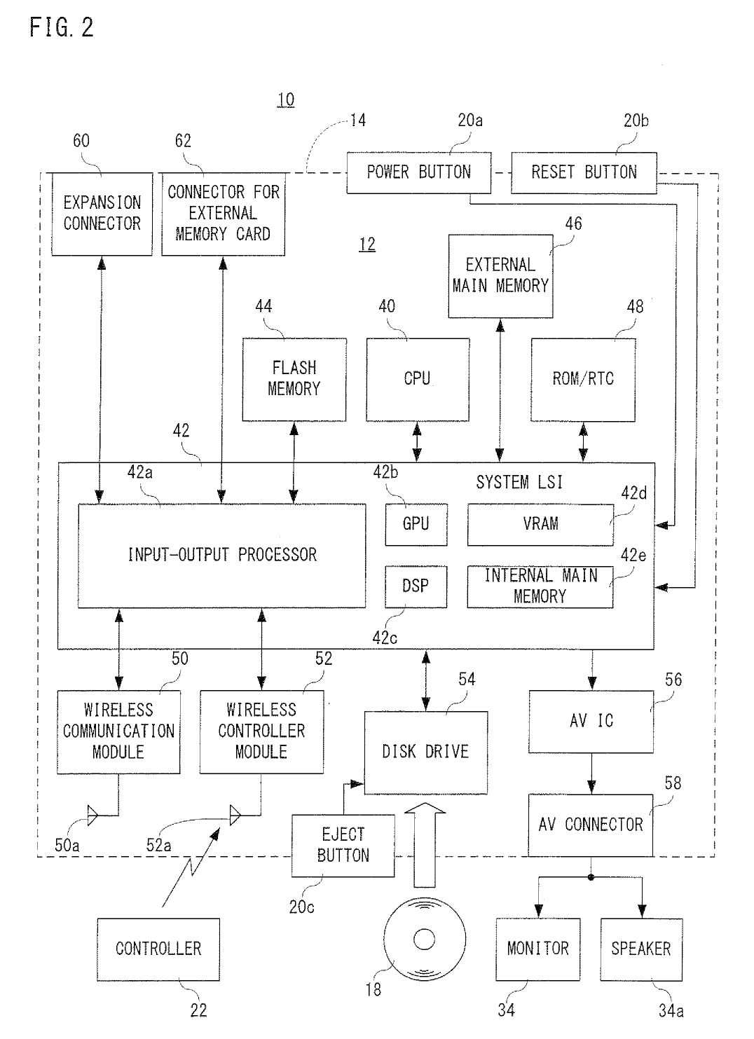

The game apparatus 12 includes a roughly rectangular parallelepiped housing 14, and the housing 14 is furnished with a disk slot 16 on a front surface. An optical disk 18 as one example of an information storage medium storing a game program, etc. is inserted from the disk slot 16 to be loaded into a disk drive 54 (see FIG. 2) within the housing 14. Around the disk slot 16, an LED and a light guide plate are arranged so as to be light on or off in accordance with various processing.

Furthermore, on a front surface of the housing 14 of the game apparatus 12, a power button 20a and a reset button 20b are provided at the upper part thereof, and an eject button 20c is provided below them. In addition, a connector cover for external memory card 28 is provided between the reset button 20b and the eject button 20c, and in the vicinity of the disk slot 16. Inside the connector cover for external memory card 28, an connector for external memory card 62 (see FIG. 2) is provided, through which an external memory card (hereinafter simply referred to as a “memory card”) not shown is inserted. The memory card is employed for loading the game program, etc. read from the optical disk 18 to temporarily store it, storing (saving) game data (result data or proceeding data of the game) of the game played by means of the game system 10, and so forth. It should be noted that storing the game data described above may be performed on an internal memory, such as a flash memory 44 (see FIG. 2) provided inside the game apparatus 12 in place of the memory card. Also, the memory card may be utilized as a backup memory of the internal memory.

It should be noted that a general-purpose SD card can be employed as a memory card, but other general-purpose memory cards, such as memory sticks, multimedia cards (registered trademark) can be employed.

The game apparatus 12 has an AV cable connector 58 (see FIG. 2) on the rear surface of the housing 14, and by utilizing the AV cable connector 58, a monitor 34 and a speaker 34a are connected to the game apparatus 12 through an AV cable 32a. The monitor 34 and the speaker 34a are typically a color television receiver, and through the AV cable 32a, a video signal from the game apparatus 12 is input to a video input terminal of the color television, and a sound signal from the game apparatus 12 is input to a sound input terminal thereof. Accordingly, a game image of a three-dimensional (3D) video game, for example, is displayed on the screen of the color television (monitor) 34, and stereo game sound, such as a game music, a sound effect, etc. is output from right and left speakers 34a. Around the monitor 34 (on the top side of the monitor 34, in this embodiment), a marker unit 34b including two infrared ray LEDs (markers) 340m and 340n is provided. The marker unit 34b is connected to the game apparatus 12 through a power source cable 32b. Accordingly, the marker unit 34b is supplied with power from the game apparatus 12. Thus, the markers 340m and 340n emit lights so as to output infrared rays in front of the monitor 34.

Furthermore, the power of the game apparatus 12 is applied by means of a general AC adapter (not illustrated). The AC adapter is inserted into a standard wall socket for home use, and the game apparatus 12 transforms the house current (commercial power supply) to a low DC voltage signal suitable for driving. In another embodiment, a battery may be utilized as a power supply.

In the game system 10, a user or a player turns the power of the game apparatus 12 on for playing the game (or applications other than the game). Then, the user selects an appropriate optical disk 18 storing a program of a video game (or other applications the player wants to play), and loads the optical disk 18 into the disk drive 54 of the game apparatus 12. In response thereto, the game apparatus 12 starts to execute a video game or other applications on the basis of the program recorded in the optical disk 18. The user operates the controller 22 in order to apply an input to the game apparatus 12. For example, by operating any one of the operating buttons of the input means 26, a game or other application is started. Besides the operation performed on the input means 26, by moving the controller 22 itself, it is possible to move a moving image object (player object) in different directions or change the perspective of the user (camera position) in a 3-dimensional game world.

Furthermore, the programs and data of the game or other applications may be stored in advance in an internal memory like the flash memory 44 (FIG. 2) of the game apparatus 12, or downloaded from a download server on a network so as to be additionally stored in the internal memory.

FIG. 2 is a block diagram showing an electric configuration of the video game system 10 shown in FIG. 1 embodiment. Although illustration is omitted, respective components within the housing 14 are mounted on a printed board. As shown in FIG. 2, the game apparatus 12 has a CPU 40. The CPU 40 functions as a game processor. The CPU 40 is connected with a system LSI 42. The system LSI 42 is connected with an external main memory 46, a ROM/RTC 48, a disk drive 54, and an AV IC 56.

The external main memory 46 is utilized as a work area and a buffer area of the CPU 40 by storing programs like a game program, etc. and various data. The ROM/RTC 48, which is a so-called boot ROM, is incorporated with a program for activating the game apparatus 12, and is provided with a time circuit for counting a time. The disk drive 54 reads program data, texture data, etc. from the optical disk 18, and writes them in an internal main memory 42e described later or the external main memory 46 under the control of the CPU 40.

The system LSI 42 is provided with an input-output processor 42a, a GPU (Graphics Processor Unit) 42b, a DSP (Digital Signal Processor) 42c, a VRAM 42d and an internal main memory 42e, and these are connected with one another by internal buses although illustration is omitted.

The input-output processor (I/O processor) 42a executes transmission and reception of data and executes download of the data.

The GPU 42b is made up of a part of a drawing means, and receives a graphics command (construction command) from the CPU 40 to generate game image data according to the command. Additionally, the CPU 40 applies an image generating program required for generating game image data to the GPU 42b in addition to the graphics command.

Although illustration is omitted, the GPU 42b is connected with the VRAM 42d as described above. The GPU 42b accesses the VRAM 42d to acquire data (image data: data such as polygon data, texture data, etc.) required to execute the construction command. Here, the CPU 40 writes image data required for drawing to the VRAM 42d via the GPU 42b. The GPU 42b accesses the VRAM 42d to create game image data for drawing.

In this embodiment, a case that the GPU 42b generates game image data is explained, but in a case of executing an arbitrary application except for the game application, the GPU 42b generates image data as to the arbitrary application.

Furthermore, the DSP 42c functions as an audio processor, and generates audio data corresponding to a sound, a voice, music, or the like to be output from the speaker 34a by means of the sound data and the sound wave (tone) data stored in the internal main memory 42e and the external main memory 46.

The game image data and audio data which are generated as described above are read by the AV IC 56, and output to the monitor 34 and the speaker 34a via the AV connector 58. Accordingly, a game screen is displayed on the monitor 34, and a sound (music) necessary for the game is output from the speaker 34a.

Furthermore, the input-output processor 42a is connected with a flash memory 44, a wireless communication module 50 and a wireless controller module 52, and is also connected with an expansion connector 60 and a connector for external memory card 62. The wireless communication module 50 is connected with an antenna 50a, and the wireless controller module 52 is connected with an antenna 52a.

The input-output processor 42a can communicate with other game apparatuses and various servers to be connected to a network via a wireless communication module 50. It should be noted that it is possible to directly communicate with another game apparatus without going through the network. The input-output processor 42a periodically accesses the flash memory 44 to detect the presence or absence of data (referred to as data to be transmitted) being required to be transmitted to a network, and transmits it to the network via the wireless communication module 50 and the antenna 50a in a case that data to be transmitted is present. Furthermore, the input-output processor 42a receives data (referred to as received data) transmitted from another game apparatuses via the network, the antenna 50a and the wireless communication module 50, and stores the received data in the flash memory 44. In a certain case, the reception data is abandoned as it is. In addition, the input-output processor 42a receives data (download data) downloaded from the download server via the network, the antenna 50a and the wireless communication module 50, and stores the download data in the flash memory 44.

Furthermore, the input-output processor 42a receives input data transmitted from the controller 22 via the antenna 52a and the wireless controller module 52, and (temporarily) stores it in the buffer area of the internal main memory 42e or the external main memory 46. The input data is erased from the buffer area after being utilized in game processing by the CPU 40.

In this embodiment, as described above, the wireless controller module 52 makes communications with the controller 22 in accordance with Bluetooth standards.

In addition, the input-output processor 42a is connected with the expansion connector 60 and the connector for external memory card 62. The expansion connector 60 is a connector for interfaces, such as USB, SCSI, etc., and can be connected with medium such as an external storage and peripheral devices such as another controller. Furthermore, the expansion connector 60 is connected with a cable LAN adaptor, and can utilize the cable LAN in place of the wireless communication module 50. The connector for external memory card 62 can be connected with an external storage like a memory card. Thus, the input-output processor 42a, for example, accesses the external storage via the expansion connector 60 and the connector for external memory card 62 to store and read the data.

Although a detailed description is omitted, as shown in FIG. 1, the game apparatus 12 (housing 14) is furnished with the power button 20a, the reset button 20b, and the eject button 20c. The power button 20a is connected to the system LSI 42. When the power button 20a is turned on, the system LSI 42 sets a mode of a normal energized state (referred to as “normal mode”) in which the respective components of the game apparatus 12 are supplied with power through an AC adapter not shown. On the other hand, when the power button 20a is turned off, the system LSI 42 sets a mode in which a part of the components of the game apparatus 12 is supplied with power, and the power consumption is reduced to minimum (hereinafter referred to as “standby mode”). In this embodiment, in a case that the standby mode is set, the system LSI 42 issues an instruction to stop supplying the power to the components except for the input-output processor 42a, the flash memory 44, the external main memory 46, the ROM/RTC 48 and the wireless communication module 50, and the wireless controller module 52. Accordingly, the standby mode is a mode in which the CPU 40 never executes an application.

Although the system LSI 42 is supplied with power even in the standby mode, supply of clocks to the GPU 42b, the DSP 42c and the VRAM 42d are stopped so as not to be driven, realizing reduction in power consumption.

Although illustration is omitted, inside the housing 14 of the game apparatus 12, a fan is provided for excluding heat of the IC, such as the CPU 40, the system LSI 42, etc. to outside. In the standby mode, the fan is also stopped.

However, in a case that the standby mode is not desired to be utilized, when the power button 20a is turned off, by making the standby mode unusable, the power supply to all the circuit components are completely stopped.

Furthermore, switching between the normal mode and the standby mode can be performed by turning on and off the power switch 26h of the controller 22 by remote control. If the remote control is not performed, setting is made such that the power supply to the wireless controller module 52a is not performed in the standby mode.

The reset button 20b is also connected with the system LSI 42. When the reset button 20b is pushed, the system LSI 42 restarts the activation program of the game apparatus 12. The eject button 20c is connected to the disk drive 54. When the eject button 20c is pushed, the optical disk 18 is removed from the disk drive 54.

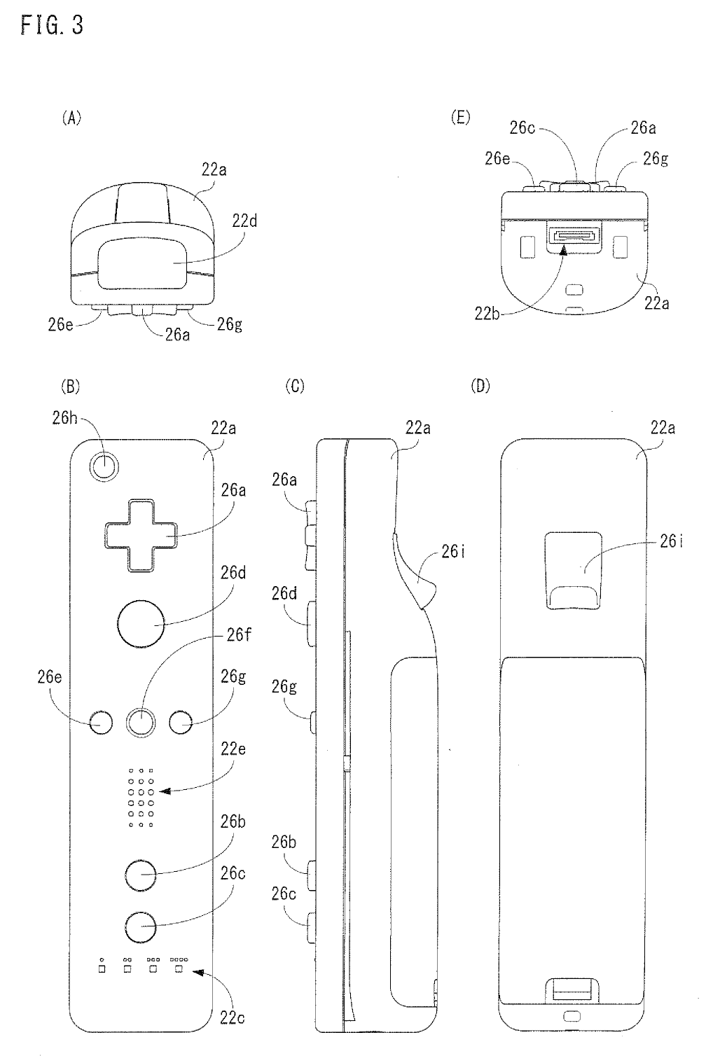

Each of FIG. 3(A) to FIG. 3(E) shows one example of an external appearance of the controller 22. FIG. 3(A) shows a front end surface of the controller 22, FIG. 3(B) shows a top surface of the controller 22, FIG. 3(C) shows a right side surface of the controller 22, FIG. 3(D) shows a lower surface of the controller 22, and FIG. 3(E) shows a back end surface of the controller 22.

Referring to FIG. 3(A) and FIG. 3(E), the controller 22 has a housing 22a formed by plastic molding, for example. The housing 22a is formed into an approximately rectangular parallelepiped shape and has a size small enough to be held by one hand of a user. The housing 22a (controller 22) is provided with the input means (a plurality of buttons or switches) 26. Specifically, as shown in FIG. 3(B), on an upper face of the housing 22a, there are provided a cross key 26a, a 1 button 26b, a 2 button 26c, an A button 26d, a −button 26e, a HOME button 26f, a +button 26g and a power switch 26h. Moreover, as shown in FIG. 3(C) and FIG. 3(D), an inclined surface is formed on a lower surface of the housing 22a, and a B-trigger switch 26i is formed on the inclined surface.

The cross key 26a is a four directional push switch, including four directions of front (or upper), back (or lower), right and left operation parts. By operating any one of the operation parts, it is possible to instruct a moving direction of a character or object (player character or player object) that is be operable by a player or instruct a moving direction of a cursor.

The 1 button 26b and the 2 button 26c are respectively push button switches, and are used for a game operation, such as adjustment of a viewpoint position and a viewpoint direction on displaying the 3D game image, i.e. a position and an image angle of a virtual camera, and the like. Alternatively, the 1 button 26b and the 2 button 26c can be used for the same operations as those of the A-button 26d and the B-trigger switch 26i or an auxiliary operation.

The A-button switch 26d is the push button switch, and is used for causing the player character or the player object to take an action other than that instructed by a directional instruction, specifically arbitrary actions such as hitting (punching), throwing, grasping (acquiring), riding, and jumping, etc. For example, in an action game, it is possible to give an instruction to jump, punch, move a weapon, and so forth. Also, in a roll playing game (RPG) and a simulation RPG, it is possible to instruct to acquire an item, select and determine the weapon and command, and so forth.

The −button 26e, the HOME button 26f, the +button 26g, and the power supply switch 26h are also push button switches. The −button 26e is used for selecting a game mode. The HOME button 26f is used for displaying a game menu (menu screen). The +button 26g is used for starting (re-starting) or pausing the game. The power supply switch 26h is used for turning on/off a power supply of the game apparatus 12 by remote control.

In this embodiment, note that the power supply switch for turning on/off the controller 22 itself is not provided, and the controller 22 is set at on-state by operating any one of the switches or buttons of the input means 26 of the controller 22, and when not operated for a certain period of time (30 seconds, for example) or more, the controller 22 is automatically set at off-state.

The B-trigger switch 26i is also the push button switch, and is mainly used for inputting like a trigger such as shooting and designating a position selected by the controller 22. In a case that the B-trigger switch 26i is continued to be pushed, it is possible to make movements and parameters of the player object constant. In a fixed case, the B-trigger switch 26i functions in the same way as a normal B-button, and is used for canceling the action determined by the A-button 26d.

As shown in FIG. 3(E), an external expansion connector 22b is provided on a back end surface of the housing 22a, and as shown in FIG. 3(B), an indicator 22c is provided on the top surface and at the rear of the housing 22a. The external expansion connector 22b is utilized for connecting another expansion controller not shown. The indicator 22c is made up of four LEDs, for example, and shows identification information (controller number) of the controller 22 corresponding to the lighting LED by lighting any one of the four LEDs, and shows the remaining amount of power of the controller 22 depending on the number of LEDs to be emitted.

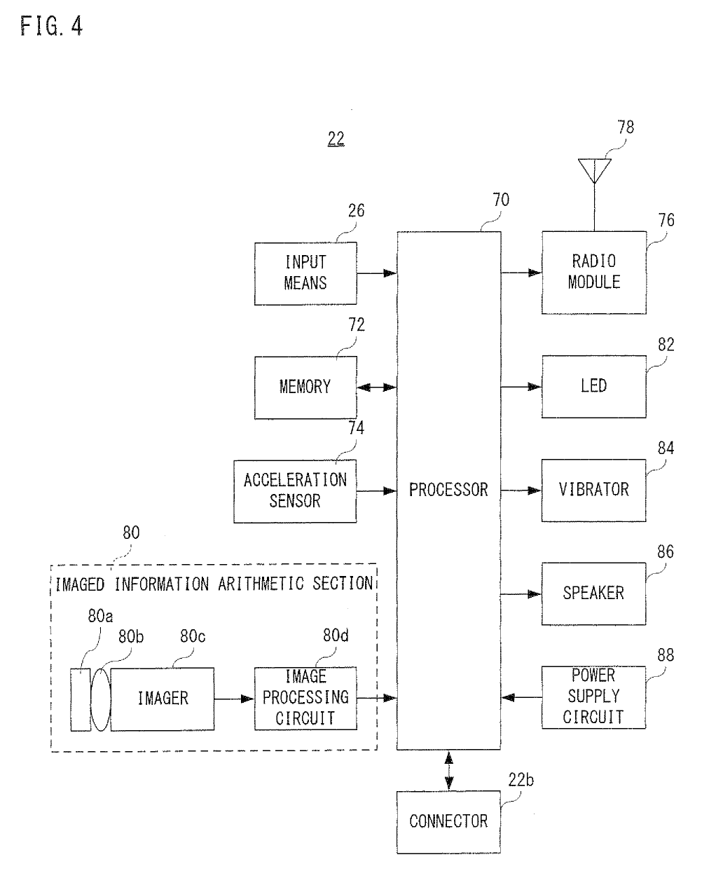

In addition, the controller 22 has an imaged information arithmetic section 80 (see FIG. 4), and is provided with a light incident opening 22d of the imaged information arithmetic section 80 on the front end surface of the housing 22a as shown in FIG. 3(A). Furthermore, the controller 22 has a speaker 86 (see FIG. 4), and the speaker 86 is provided inside the housing 22a at the position corresponding to a sound release hole 22e between the 1 button 26b and the HOME button 26f on the tope surface of the housing 22a as shown in FIG. 3(B).

Note that, the shape of the controller 22 and the shape, number and setting position of each input means 26 shown in FIG. 3(A) to FIG. 3(E) are simply examples, and needless to say, even if they are suitably modified, the present invention can be realized.

FIG. 4 is a block diagram showing an electric configuration of the controller 22. Referring to FIG. 4, the controller 22 includes a processor 70, and the processor 70 is connected with the external expansion connector 22b, the input means 26, a memory 72, an acceleration sensor 74, a radio module 76, the imaged information arithmetic section 80, an LED 82 (the indicator 22c), an vibrator 84, a speaker 86, and a power supply circuit 88 by an internal bus (not shown). Moreover, an antenna 78 is connected to the radio module 76.

The processor 70 is in charge of an overall control of the controller 22, and transmits (inputs) information (input information) inputted by the input means 26, the acceleration sensor 74, and the imaged information arithmetic section 80 as input data, to the game apparatus 12 via the radio module 76 and the antenna 78. At this time, the processor 70 uses the memory 72 as a working area or a buffer area.

An operation signal (operation data) from the aforementioned input means 26 (26a to 26i) is inputted to the processor 70, and the processor 70 stores the operation data once in the memory 72.

Moreover, the acceleration sensor 74 detects each acceleration of the controller 22 in directions of three axes of vertical direction (y-axial direction), lateral direction (x-axial direction), and forward and rearward directions (z-axial direction). The acceleration sensor 74 is typically an acceleration sensor of an electrostatic capacity type, but the acceleration sensor of other type may also be used.

For example, the acceleration sensor 74 detects the accelerations (ax, ay, and az) in each direction of x-axis, y-axis, z-axis for each first predetermined time, and inputs the data of the acceleration (acceleration data) thus detected in the processor 70. For example, the acceleration sensor 74 detects the acceleration in each direction of the axes in a range from −2.0 g to 2.0 g (g indicates a gravitational acceleration. The same thing can be the hereafter.) The processor 70 detects the acceleration data given from the acceleration sensor 74 for each second predetermined time, and stores it in the memory 72 once. The processor 70 creates input data including at least one of the operation data, acceleration data and marker coordinate data as described later, and transmits the input data thus created to the game apparatus 12 for each third predetermined time (5 msec, for example).

In this embodiment, although omitted in FIG. 3(A) to FIG. 3(E), the acceleration sensor 74 is provided on the circuit board at a position corresponding to the place where the cross key 26a is arranged inside the housing 22a.

It will be appreciated by those skilled in the art from the description of this specification that a computer, such as a processor (CPU 40, for example) of the game apparatus 12 or the processor (processor 70, for example) of the controller 22 executes processing on the basis of acceleration data output from the acceleration sensors 74 to thereby estimate or calculate (determine) more information relating to the controller 22.

In a case that processing is executed on the side of the computer assuming that the controller 22 incorporated with the single axis acceleration sensor 74 is in a static state, that is, processing is executed considering that accelerations detected by the acceleration sensor 74 is only gravitational accelerations, if the controller 22 is actually in a static state, it is possible to know whether or not the orientations of the controller 22 is inclined with respect to the direction of gravity or to what extent they are inclined on the basis of the detected acceleration. More specifically, when a state in which the detection axis of the acceleration sensor 74 is directed to a vertically downward direction is taken as a reference, merely whether or not 1 G (gravitational acceleration) is imposed on can show whether or not the controller 22 is inclined, and the size can show to what extent it is inclined.

Furthermore, if a multi-axes acceleration sensor 74 is applied, by further performing processing on acceleration data of each axis, it is possible to more precisely know to what extent the controller 22 is inclined with respect to the direction of gravity. In this case, on the basis of outputs from the acceleration sensor 74, the processor 70 may perform processing of calculating data of inclined angle of the controller 22, but perform processing of estimating an approximate inclination on the basis of the outputs from the acceleration sensor 74 without performing the processing of calculating the data of the inclined angle. Thus, by using the acceleration sensor 74 in conjunction with the processor 70, it is possible to determine an inclination, an orientation or a position of the controller 22.

On the other hand, assuming that the acceleration sensor 74 is in a dynamic state, accelerations according to the movement of the acceleration sensor 74 is detected in addition to the gravitational acceleration component, and therefore, if the gravitational acceleration component is removed by predetermined processing, it is possible to know a moving direction, etc. More specifically, in a case that the controller 22 being furnished with the acceleration sensor 74 is accelerated and moved by the hand of the user, acceleration data generated by the acceleration sensor 74 is processed, and whereby, it is possible to calculate various movements and/or positions of the controller 22.

Additionally, even when assuming that the acceleration sensor 74 is in a dynamic state, if an acceleration in correspondence with the movement of the acceleration sensor 74 is removed by the predetermined processing, it is possible to know the inclination with respect to the direction of gravity. In another embodiment, the acceleration sensor 74 may contain a built-in signal processing apparatus or other kinds of dedicated processing apparatuses for performing desired processing on the acceleration signal (acceleration data) output from the incorporated acceleration detecting means before outputting the acceleration data to the processor 70. For example, in a case that the acceleration sensor 74 is one for detecting a static acceleration (gravitational acceleration, for example), the built-in or dedicated processing apparatuses may be one for transforming the detected acceleration data into the inclined angle (or other preferable parameters) corresponding thereto.

The radio module 76 modulates a carrier of a predetermined frequency by the input data by using a technique of Bluetooth, for example, and emits its weak radio wave signal from the antenna 78. Namely, the input data is modulated to the weak radio wave signal by the radio module 76 and transmitted from the antenna 78 (controller 22). The weak radio wave signal thus transmitted is received by the radio controller module 52 provided to the aforementioned game apparatus 12. The weak radio wave thus received is subjected to demodulating and decoding processing. This makes it possible for the game apparatus 12 (CPU 40) to acquire the input data from the controller 22. Then, the CPU 40 performs game processing, following the obtained input data and a program (game program or application program).

In addition, as described above, the controller 22 is provided with the imaged information arithmetic section 80. The imaged information arithmetic section 80 is made up of an infrared rays filter 80a, a lens 80b, an imager 80c, and an image processing circuit 80d. The infrared rays filter 80a passes only infrared rays from the light incident from the front of the controller 22. As described above, the markers 340m and 340n placed near (around) the display screen of the monitor 34 are infrared LEDs for outputting infrared lights forward the monitor 34. Accordingly, by providing the infrared rays filter 80a, it is possible to image the image of the markers 340m and 340n more accurately. The lens 80b condenses the infrared rays passing thorough the infrared rays filter 80a to emit them to the imager 80c. The imager 80c is a solid imager, such as a CMOS sensor and a CCD, for example, and images the infrared rays condensed by the lens 80b. Accordingly, the imager 80c images only the infrared rays passing through the infrared rays filter 80a to generate image data. Hereafter, the image imaged by the imager 80c is called an “imaged image”. The image data generated by the imager 80c is processed by the image processing circuit 80d. The image processing circuit 80d calculates a position of an object to be imaged (markers 340m and 340n) within the imaged image, and outputs each coordinate value indicative of the position to the processor 70 as imaged data for each fourth predetermined time. It should be noted that a description of the process in the image processing circuit 80d is made later.

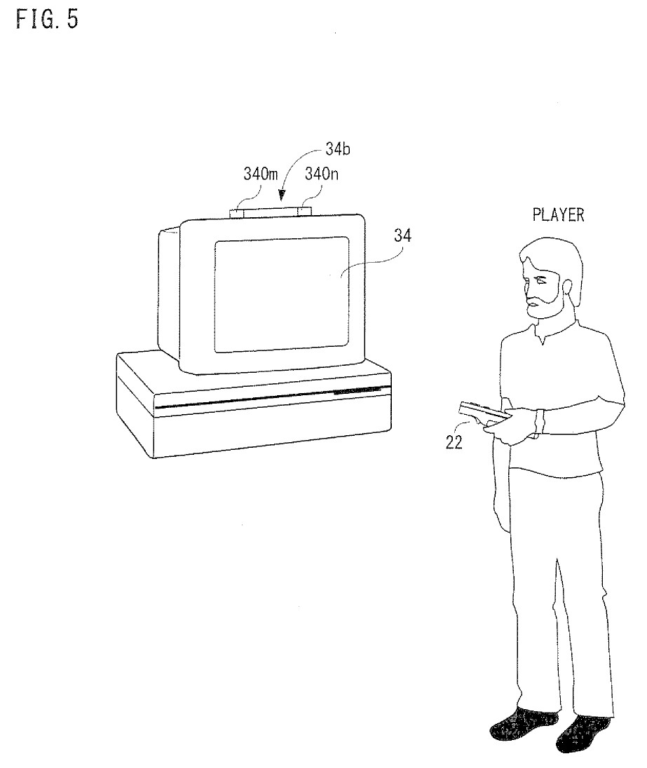

FIG. 5 is an illustrative view summarizing a state when a player plays a game by utilizing a controller 22. As shown in FIG. 5, when playing the game by means of the controller 22 in the video game system 10, the player holds the controller 22 with one hand. Strictly speaking, the player holds the controller 22 in a state that the front end surface (the side of the incident light opening 22d of the light imaged by the imaged information arithmetic section 80) of the controller 22 is oriented to the markers 340m and 340n. It should be noted that as can be understood from FIG. 1 the markers 340m and 340n are placed in parallel with the horizontal direction of the screen of the monitor 34. In this state, the player performs a game operation by changing a position on the screen indicated by the controller 22, and changing a distance between the controller 22 and each of the markers 340m and 340n.

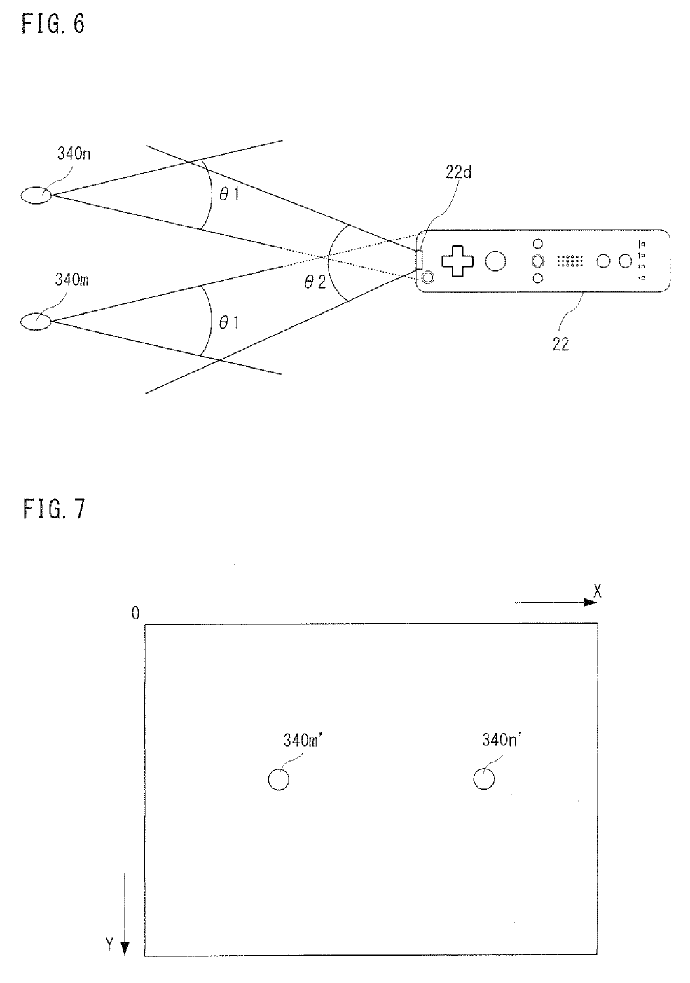

FIG. 6 is a view showing viewing angles between the respective markers 340m and 340n, and the controller 22. As shown in FIG. 6, each of the markers 340m and 340n emits infrared ray within a range of a viewing angle θ1. Also, the imager 80c of the imaged information arithmetic section 80 can receive incident light within the range of the viewing angle θ2 talking the line of sight of the controller 22 as a center. For example, the viewing angle θ1 of each of the markers 340m and 340n is 34° (half-value angle) while the viewing angle θ2 of the imager 80c is 41°. The player holds the controller 22 such that the imager 80c is directed and positioned so as to receive the infrared rays from the two markers 340m and 340n. More specifically, the player holds the controller 22 such that at least one of the markers 340m and 340n exists in the viewing angle θ2 of the imager 80c, and the controller 22 exists in at least one of the viewing angles θ1 of the marker 340m or 340n. In this state, the controller 22 can detect at least one of the markers 340m and 340n. The player can perform a game operation by changing the position and the orientation of the controller 22 in the range satisfying the state.

If the position and the orientation of the controller 22 are out of the range, the game operation based on the position and the orientation of the controller 22 cannot be performed. Hereafter, the above-described range is called an “operable range.”

If the controller 22 is held within the operable range, an image of each of the markers 340m and 340n is imaged by the imaged information arithmetic section 80. That is, the imaged image obtained by the imager 80c includes an image (object image) of each of the markers 340m and 340n as an object to be imaged. FIG. 7 is a view showing one example of the imaged image including object images. The image processing circuit 80d calculates coordinates (marker coordinates) indicative of the position of each of the markers 340m and 340n in the imaged image by utilizing the image data of the imaged image including the object images.

Since the object image appears as a high-intensity part in the image data of the imaged image, the image processing circuit 80d first detects the high-intensity part as a candidate of the object image. Next, the image processing circuit 80d determines whether or not the high-intensity part is an object image on the basis of the size of the detected high-intensity part. The imaged image may include images other than the object image due to sunlight through a window and light of a fluorescent lamp in the room as well as the images 340m′ and 340n′ of the two markers 340m and 340n as an object image. The determination processing whether or not the high-intensity part is an object image is executed for discriminating the images 340m′ and 340n′ of the two markers 340m and 340n as an object image from the images other than them, and accurately detecting the object image. More specifically, in the determination process, it is determined whether or not the detected high-intensity part is within the size of the preset predetermined range. Then, if the high-intensity part is within the size of the predetermined range, it is determined that the high-intensity part represents the object image. On the contrary, if the high-intensity part is not within the size of the predetermined range, it is determined that the high-intensity part represents the images other than the object image.

In addition, as to the high-intensity part which is determined to represent the object image as a result of the above-described determination processing, the image processing circuit 80d calculates the position of the high-intensity part. More specifically, the barycenter position of the high-intensity part is calculated. Here, the coordinates of the barycenter position are called a “marker coordinate”. Also, the barycenter position can be calculated with more detailed scale than the resolution of the imager 80c. Now, the resolution of the imaged image imaged by the imager 80c shall be 126×96, and the barycenter position shall be calculated with the scale of 1024×768. That is, the marker coordinate is represented by the integer from (0, 0) to (1024, 768).

Additionally, the position in the imaged image shall be represented by a coordinate system (XY coordinate system) taking the upper left of the imaged image as an origin point, the downward direction as an Y-axis positive direction, and the right direction as an X-axis positive direction.

Also, if the object image is properly detected, two high-intensity parts are determined as object images by the determination process, and therefore, two marker coordinates are calculated. The image processing circuit 80d outputs data indicative of the calculated two marker coordinates. The data (marker coordinate data) of the output marker coordinates is included in the input data by the processor 70 as described above, and transmitted to the game apparatus 12.

The game apparatus 12 (CPU 40) detects the marker coordinate data from the received input data to thereby calculate an instructed position (instructed coordinate) by the controller 22 on the screen of the monitor 34 and distances from the controller 22 to the respective markers 340m and 340n on the basis of the marker coordinate data. More specifically, from the position of the mid point of the two marker coordinates, a position to which the controller 22 faces, that is, an instructed position is calculated. The distance between the object images in the imaged image is changed depending on the distance between the controller 22 and each of the markers 340m and 340n, and therefore, the game apparatus 12 can grasp the distance between the controller 22 and each of the markers 340m and 340n by calculating the distance between the two marker coordinates.

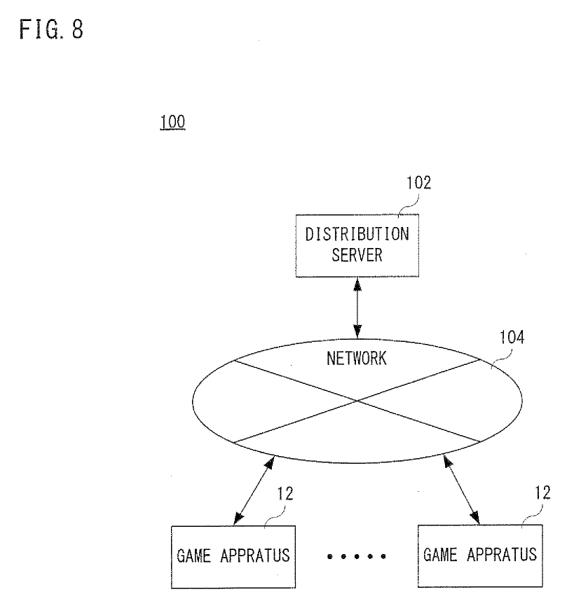

FIG. 8 is an illustrative view showing an electronic program guide displaying system 100 of one embodiment of the present invention realized by means of the above-described game apparatus 12 (game system 10). As shown in FIG. 8, the electronic program guide displaying system 100 includes a plurality of game apparatuses 12 and a distribution server 102. The respective game apparatuses 12 and the distribution server 102 are connected via a network 104, such as the Internet, a LAN so as to transmit and receive data to each other.

In the electronic program guide displaying system 100, the distribution server 102 gives program guide data to the user terminal or the game apparatus 12 being a client, so that the game apparatus 12 displays an electronic program guide on the monitor 34. The user can select a program that he or she wants to watch from the electronic program guide by an input by means of the controller 22. The result of the selection by the user is transmitted from the game apparatus 12 to the distribution server 102. The distribution server 102 totalizes the results received from the respective game apparatuses 12, and calculates a degree of popularity of each program. The degree of popularity data is transmitted from the distribution server 102 to each of the game apparatuses 12 when the electronic program guide data is distributed, for example. On the side of each game apparatus 12, a degree of popularity of each program can be displayed in the electronic program guide on the basis of the degree of popularity data. At this time, the degree of popularity of each program is represented by changing a display manner of each program information in the program guide depending on the degree of popularity.

It should be noted that in this embodiment, a case where the electronic program guide displaying system 100 is constructed by using a console type game apparatus 12 employed at home as shown in FIG. 1 is explained, but in another embodiment, other computers such as a personal computer, a cellular phone, a mobile information terminal may be used as a game apparatus 12.

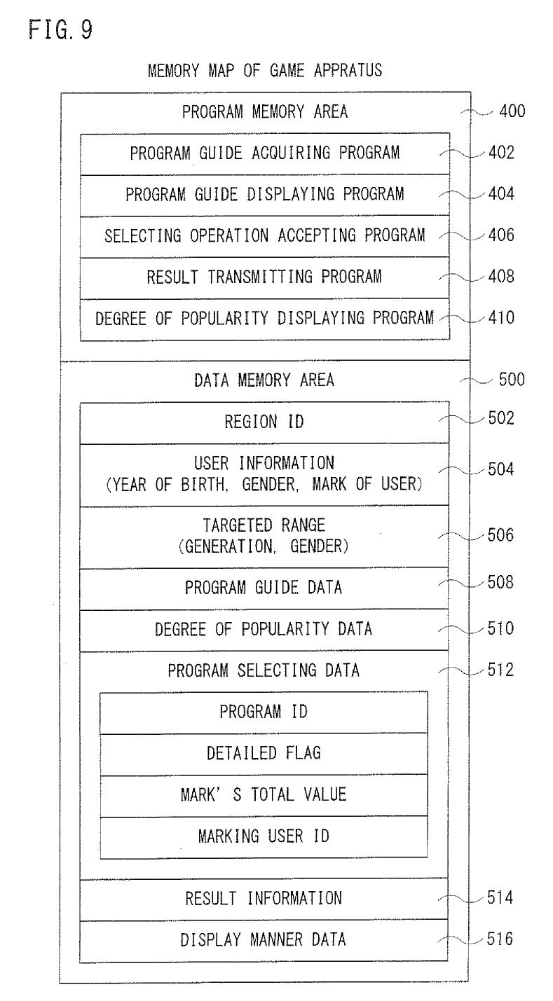

FIG. 9 shows one example of a memory map of the game apparatus 12. The memory map includes a program memory area 400 and a data memory area 500. The program and the data are read from the optical disk 18 entirely at a time, or partially and sequentially as necessary so as to be stored into the external memory 46 or the internal memory 42e. Furthermore, in the data memory area 500, data generated or fetched by the processing is also stored.

Additionally, FIG. 9 shows only a part of the memory map, in which other programs and data necessary for processing are also stored. For example, sound data for outputting a sound such as a voice, a sound effect music, etc., image data for generating a screen, a sound outputting program, an image generating and displaying program, etc. are read from the optical disk 18, and stored in the data memory area 500 or the program memory area 400. It should be noted that in this embodiment, programs and data are read from the optical disk 18, but in another embodiment, programs and data stored in advance in a nonvolatile storage medium such as the flash memory 44, etc. incorporated in the game apparatus 12, or programs or data downloaded via the network 104 may be read so as to be stored in the external memory 46 or the internal memory 42e.

In a memory area 402 of the program memory area 400, a program guide acquiring program is stored. The acquiring program is for acquiring program guide data and degree of popularity data from the distribution server 102. The transmission of a request of acquiring the program guide data and the degree of popularity data to the distribution server 102 is performed at a predetermined timing. For example, the aforementioned data may be acquired every time that the program guide displaying application starts up or may be acquired periodically such as each 24 hours, or the like. In response to the request, the distribution server 102 transmits program guide data and degree of popularity data to the game apparatus 12. The received program guide data is stored in a memory area 508, and the received degree of popularity data is stored in a memory area 510. Additionally, the program guide data and the degree of popularity data are also stored in the flash memory 44 when they are received from the distribution server 102. Specifically, the program guide data and the degree of popularity data may be read from the flash memory 44 in a case that they are not acquired every start-up, or they are not acquired at a predetermined timing, and so forth.

Basically, because a receivable broadcast station and channel vary from region to region, so that the program guide is different from region to region. Accordingly, program guide data and degree of popularity data corresponding to the region (region ID) set to the game apparatus 12 by the user is requested to be distributed. However, in another embodiment, program guide data and degree of popularity data including other regions or covering the entire regions may be acquired. Furthermore, address information of the distribution server 102 is described in the program in advance, for example.

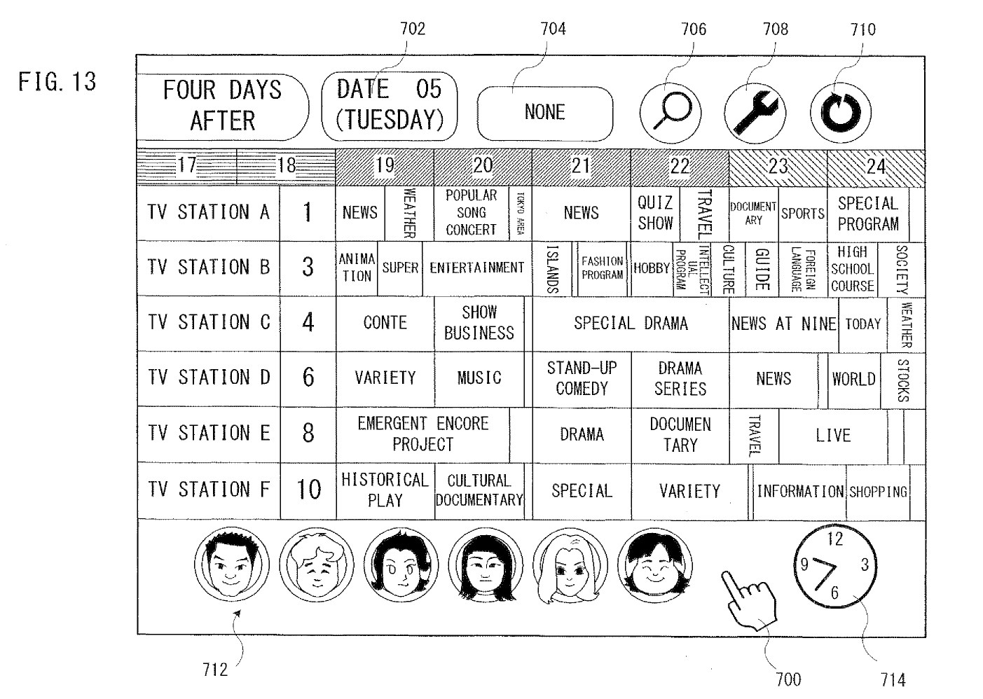

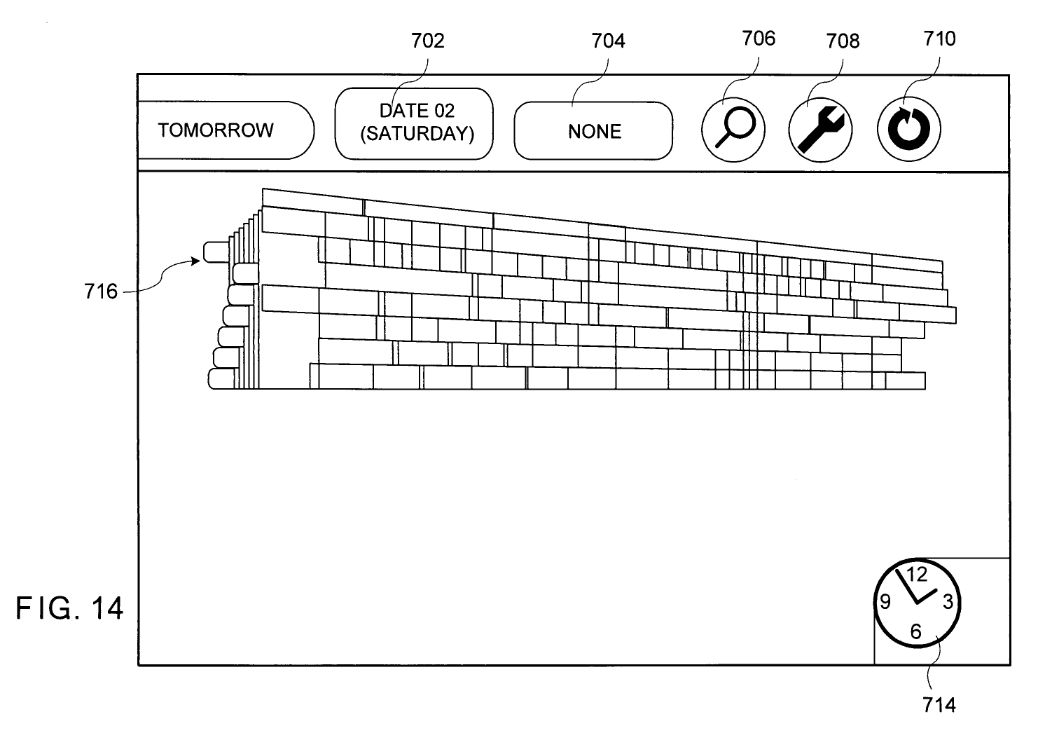

A memory area 404 stores a program guide displaying program. The displaying program is for displaying an electronic program guide on the basis of the program guide data. In the electronic program guide, a plurality of program information are displayed in a matrix manner by taking one axis as a time axis and the other axis as a broadcast station axis (see FIG. 13). As described later, in this embodiment, other than a two-dimensional (2D) electronic program guide as shown in FIG. 13, a three-dimensional (3D) electronic program guide shown in FIG. 14 can also be displayed.

A memory area 406 stores a selecting operation accepting program. The accepting program is for accepting an operation to select a desired program by the user. The user can select a desired program from the electronic program guide by operating the controller 22. In this embodiment, two kinds of selecting operations are defined such that the degree of popularity can be calculated by accurately grasping the degree of interest in a program by the user. As described later, the first selecting operation is an operation for displaying detailed information of a program, and the second selecting operation is a program for marking a program. The detailed information is for confirming a detailed content of a program, and the fact that the detailed information is displayed shows that the user is interested at least in the program. On the other hand, the operation for marking a program is defined as a necessary action in order to reserve that the player will watch the program in the game apparatus 12, and the fact that the user marks the program shows that the user has increasing interest in the program. Depending on the degree of interest by the user, two different kinds of selecting operations are accepted. When at least one selecting operation out of the two kinds of the selecting operations is accepted, program selecting data indicating a selection result of the program corresponding to the kind of the selecting operation is generated so as to be stored in a memory area 512.

In a memory area 408, a result transmitting program is stored. The transmitting program is for generating result information indicating a selection result of a program in the game apparatus 12 and transmitting it to the distribution server 102. The result information is generated on the basis of the region ID in the memory area 502, the program selecting data in the memory area 512, etc. so as to be stored in a memory area 514. Then, the result information is transmitted to the distribution server 102 at a predetermined transmission timing. For example, when selection of a program is performed periodically or at first to generate program selecting data, or when selection of a program is changed or newly performed to update program selecting data, the result information is generated and then transmitted to the distribution server 102.

A memory area 410 stores a degree of popularity displaying program. The displaying program is for displaying a degree of popularity of each program, and according to this displaying program, a display manner of each program information in the program guide is changed on the basis of the degree of popularity data. Here, in this embodiment, degree of popularity data corresponding to a targeted range (gender-basis, generation-basis) stored in a memory area 506 is utilized. Furthermore, in this embodiment, the display manner is set in advance depending on a stage or a level of the degree of popularity. More specifically, as described later, a color density of each program information in the program guide is changed according to the degree of popularity. Additionally, if a program guide is displayed by a 3-D image, the height of the field of each program information is changed depending on the degree of popularity.

Here, the display manner of each program information may be changed on the basis of the display manner data stored in advance like this embodiment, and in another embodiment, without the display manner data being prepared in advance, values of the color density and heights may be calculated from a predetermined relational expression on the basis of the degree of popularity.

The memory area 502 of the data memory area 500 stores a region ID. As described above, the program guide is basically different from region to region. Thus, at an initial setting, or the like, the user is required to input where he or she lives such as a region (prefectures, etc.), and a region ID corresponding to the input region is stored.

A memory area 504 stores user information. The user information includes private information of each user who is brought into correspondence with a user ID. The kind of the private information that the user is required to input can be arbitrarily set, but includes a year of birth and a gender of the user in this embodiment. In the distribution server 102, a degree of popularity for each kind of the private information is calculated. The user information further includes data of a mark (mark icon 712) to be used at a selecting operation by each user. The year of birth and gender of the user and the mark are requested to input by the user at the initial setting, or the like, and the input year of birth, gender and mark are stored by being brought into correspondence with the user ID. The game apparatus 12 can register user information of a plurality of users, and allows each of the users which has made registration to select a program that he or she wants to watch. For example, if user information of each of family members is registered, each of the family members can select a program that he or she wants to watch with a single game apparatus 12.

The memory area 506 stores a targeted range when a degree of popularity is displayed. In this embodiment, a gender and a generation can be set. That is, it is possible to display a degree of popularity of each program when the set gender and generation are targeted to be totalized. The targeted range may be input by the user at an initial setting, or the like. For example, both genders and all generations are set as a default targeted range, and this may be changed to a desired gender and a generation by an input by the user at the initial setting, or the like.

It should be noted that the information set at the initial setting, or the like such as a region ID, user information, a targeted range, etc. is stored in the flash memory 44 when it is set at first or changed, and is read from the flash memory 44 at a next start-up.

The memory area 508 stores program guide data received according to the program guide acquiring program. As shown in this embodiment, in a case that the distribution server 102 distributes a region-based program guide, the received program guide data is data corresponding to the region ID registered in the game apparatus 12. As to the program guide data, information on each program is stored by being brought into correspondence with the program ID. The information on the program includes a broadcast station, a channel, a date, a start time, a stop time, a broadcasting hour, a program name, a genre, detailed information, etc. It should be noted that the structure of the program guide data can be arbitrarily changed, and information on each program may be stored for each broadcast station, for example.

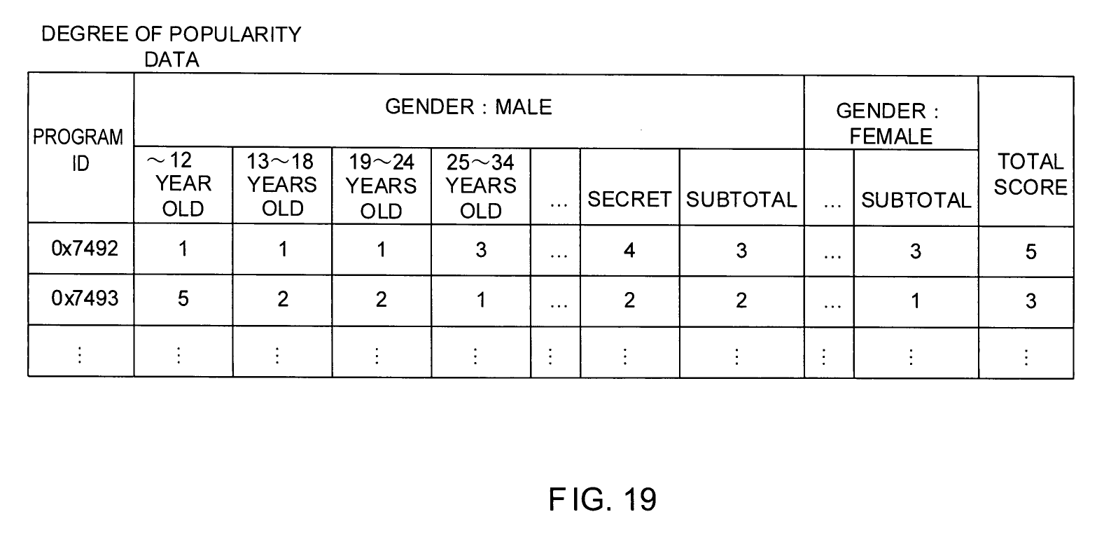

The memory area 510 stores degree of popularity data received by the program guide acquiring program. The degree of popularity is calculated by totalizing the results of the selections by a number of game apparatuses 12 in the distribution server 102 in this embodiment as described later. As to the degree of popularity data, a degree of popularity of each program is stored by being brought into correspondence with the program ID (see FIG. 19). Furthermore, the degree of popularity is represented by a plurality of stages or levels by classifying the totalization results into a plurality of stages or levels (five stages in this embodiment). Thus, it is possible to display the degree of popularity of each program by means of the plurality of stages or levels. In addition, in this embodiment, the degree of popularity of the set targeted range is displayed, and therefore, in the degree of popularity data, a degree of popularity for each generation and for each gender are stored.

Furthermore, in this embodiment, in view of the program guide being different from region to region, the distribution server 102 calculates a degree of popularity for each region, and therefore, the game apparatus 12 acquires and stores degree of popularity data corresponding to a region ID. However, in another embodiment, the distribution server 102 may calculate degree of popularity data aimed at all the regions, and distribute the degree of popularity data to the game apparatus 12.

Moreover, in this embodiment, in view of the number of audible users being different from one time slot to another, the distribution server 102 calculates a degree of popularity of each program for each time slot. However, in another embodiment, the distribution server 102 may calculate degree of popularity data aimed at all the time slots, and distribute the degree of popularity data to the game apparatus 12.

The memory area 512 sores program selecting data generated by the selecting operation accepting program. As described above, in this embodiment, the user can select a program by the two kinds of selecting operations. If a program is selected by a first selecting operation, the program is set to a first state, and if a program is selected by a second selecting operation, the program is set to a second state. More specifically, as to the program selecting data, selection information of each program is stored by being brought into correspondence with a program ID. The selection information includes a detail flag, a mark total value, a marking user ID, etc. The detail flag is a flag indicating whether or not the detailed information of a program is watched by the user in game apparatus 12. The detail flag is turned on when an operation of displaying the detailed information (first selecting operation) of the program is performed. Furthermore, the mark total value is a total number of users who marks the program in the game apparatus 12, and the mark total value is added by one when an operation of marking a program (second selecting operation) is performed. In addition, the marking user ID is information indicating an identification number of the user who marks a program in the game apparatus 12, and as the information, the user ID corresponding to the mark icon 712 (see FIG. 13) used when the second selecting operation is performed on the program is specified and stored.

It should be noted that the program selecting data records which user selects which program, so that by reference to the program selecting data, each program information is displayed in different colors for each user in the program guide, for example, to thereby show that each of the program information is selected by which user. Also, the program selecting data is stored in the flash memory 44. Then, at the next start-up of the program guide displaying application, by reference to the program selecting data in the flash memory 44, the selection result selected in the past by the user can be displayed on the program guide.

Additionally, in this embodiment, if the first selecting operation is performed on a program by the user of the game apparatus 12 even once to display the detailed information, the detail flag of the program is turned on. In another embodiment, like in a case of the second selecting operation, an ID of the user who performs the first selecting operation on a program is stored and moreover, the values indicating the total value of users may be stored as a detail flag.

The memory area 514 stores result information which is generated by the result transmitting program, and is to be transmitted to the distribution server 102. In the game apparatus 12, the result information is data indicating a selection result of a program, and in the distribution server 102, degree of popularity data from the result information is calculated.

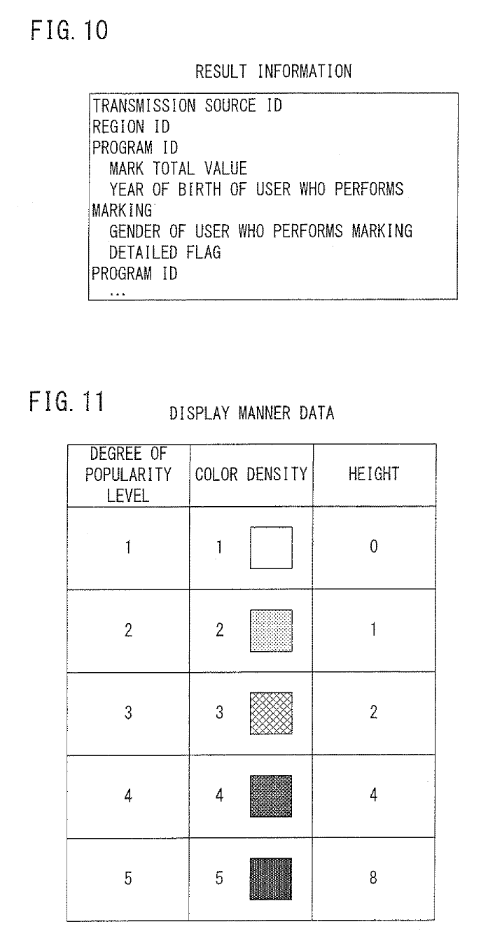

The result information includes a transmission source ID and a region ID as shown in FIG. 10. The transmission source ID is identification information of the game apparatus 12, and may be an identification number stored in advance in the ROM/RTC 48, generated from the identification number, or generated from an MAC address of the radio communication module 50, for example. The region ID is fetched from the memory area 502. In addition, the result information stores, as information indicating a detail of a selection of a program, a mark total value, a year of birth of a user who performs marking, a gender of a user who performs marking, a detail flag, etc. by being brought into correspondence with a program ID of the selected program. The total value of marks of each program and the detail flag are acquired from the program selecting data memory area 512. Furthermore, a year of birth and a gender of a user who marks each program are acquired by reading, from the user information memory area 504, the year of birth and the gender corresponding to the user ID of the user who performs marking in the program selecting data memory area 512. If a plurality of user IDs are stored as the user ID of the user who performs marking, the year of birth and the gender of each of the plurality of users are stored.

A memory area 516 stores display manner data for changing a display manner of each program information in the program guide depending on the degree of popularity. As to the display manner data, as shown in FIG. 11, a density of color and a height are stored by being brought into correspondence with a level of the degree of popularity. More specifically, in this embodiment, a color density at a background of a field of each program information in the program guide is changed depending on the degree of popularity, and therefore, data for designating an image which is set to a density at each level in advance is stored as color density data. Or, data for designating a color density in each level may be stored. For example, a color the same as that of the background at a normal state (white, for example) may be adopted when the level of the degree of popularity is 1, that is, at the lowermost level. When the level of the degree of popularity is 2 to 5, another color (red, for example) is adopted to the background, and as the level of the degree of popularity is high, the color may be deep. Alternatively, one kind of color is adopted as a background color, and the depth may be gradually dark (or light) depending on the level of the degree of popularity.

In addition, in a case that the program guide is displayed by a 3-D image, the height of the filed of the program information can be represented on the screen, and in this embodiment, the height is changed depending on the level of the degree of popularity. More specifically, a direction being orthogonal to a broadcast station axis and a time axis of the program guide which is displayed in a matrix manner and being on a near side of the screen is set to be a direction of the height, and a numerical value indicating a height (degree of protrusion) of the direction is set in advance so as to be large depending on the level of the degree of popularity. In the example shown in FIG. 11, the height is set so as to be 0 when the level of the degree of popularity is 1 and become higher depending on the level of the degree of popularity when the level of the degree of popularity is 2-5.

It should be noted that in the example shown in FIG. 11, the height is set so as to be great like an exponential function as the level of the degree of popularity is increased, but it is not restricted thereto. For example, as the level of the degree of popularity is increased, the value of the height may be large by a certain amount like 0, 1, 2, 3, 4.

Furthermore, in this embodiment, in the 3-D program guide, both of the color density and the height are changed depending on the level of the degree of popularity, but in another embodiment, in the 3-D program guide, only the height may be changed, or only the color density may be changed similar to the 2D-program guide.

Moreover, if the level of the degree of popularity of each program can be clearly represented in the program guide the user can intuitively grasp the degree of popularity, and therefore, the change in the display manner of each program information of the program guide is not restricted to the change in color density and height of the field of the program information and can be changed as necessary. For example, it is conceived that the color or tone of the background in the field of each program information may be changed for each level of the degree of popularity. Or, the frame-shape of the field of each program information may be changed to a different shape for each level of the degree of popularity. Or, a color of letters, a color density, a font, a size, or the like of the program information may be changed for each level of the degree of popularity.

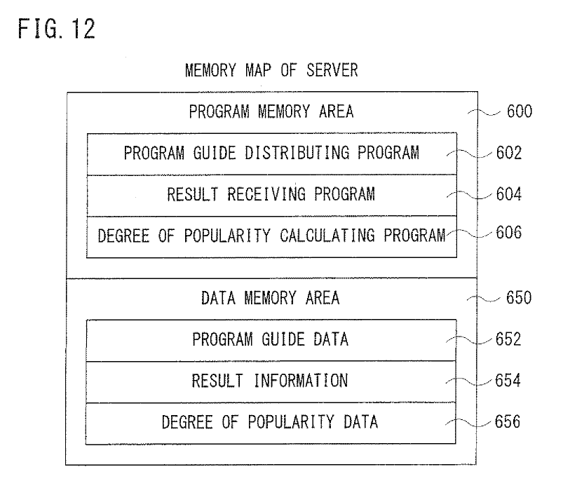

FIG. 12 shows one example of a memory map of the distribution server 102. The memory map includes a program memory area 600 and a data memory area 650. A program for controlling an operation of the computer (CPU) of the distribution server 102 and data necessary for the processing are stored, for example, from the information storage medium to an HDD or stored in a ROM in advance so as to be read to a RAM as necessary. Furthermore, the data memory area 650 also stores data generated or acquired by the processing. Here, FIG. 12 shows only a part of the memory map, and other programs and data required for the processing are also stored. For example, a program for fetching EPG (Electronic Program Guide) data distributed from the server of a distributor, or the like is stored.

A memory area 602 of the program memory area 600 stores a program guide distributing program. The distributing program is for distributing program guide data and degree of popularity data to each of the game apparatuses 12. The program guide data and the degree of popularity data are transmitted in response to a request from each of the game apparatuses 12.

The program guide data is generated on the basis of the EPG data fetched from the server of a distributor, or the like so as to be stored in the memory area 652. The program guide is different from region to region, and therefore, region-based program guide data is generated by being brought into correspondence with the region ID. More specifically, each program is assigned identification information (program ID). Then, for example, by storing information of each program by being brought into correspondence with the program ID, program guide data is generated. As information on each program, a broadcast station, a channel, a date, a start time of broadcasting, a stop time of broadcasting, a broadcasting hour, a program name, a genre, detailed information, etc. are included, and these are fetched from the EPG data. Furthermore, the program guide data stores information on the program by a predetermined period (one week, etc.) from the current date, for example. Accordingly, the program guide data is updated to data from the next date at a proper timing, and when the date is changed, the updated program guide data is transmitted.

Moreover, the degree of popularity data is calculated by a degree of popularity calculating program described later so as to be stored in the memory area 656. The degree of popularity is calculated from region to region, and the degree of popularity data for each region which is brought into correspondence with the region ID is stored.

When receiving request data from the game apparatus 12, the server reads the program guide data and the degree of popularity data corresponding to the region ID included in the request data, and transmits them to the game apparatus 12.

A memory area 604 stores a result receiving program. The receiving program is for receiving result information (FIG. 10) transmitted from each game apparatus 12. The received result information is stored in the memory area 654, and stored in the HDD. As shown in FIG. 10, since the result information includes a transmission source ID, in a case that result information with the same source ID has already been stored, the result information is updated.

A memory area 606 stores a degree of popularity calculating program. The calculating program is for totalizing the result information from the respective game apparatuses 12 and calculating the degree of popularity of each program data. The calculated degree of popularity data is stored in the memory area 656. The totalizing the results and the calculating the degree of popularity are executed at a predetermined timing. For example, the calculation may be periodically made, such as every 12 hours or 24 hours. Furthermore, a totalization timing may be differentiated depending on the remaining time until an airdate of each program. For example, the program which will starts within three days is calculated every 12 hours, and the program which will starts after three days or more is calculated every 24 hours.

Moreover, in this embodiment, the region-based program guide data is distributed, and therefore, result information of the respective game apparatuses 12 are totalized for each region, and degree of popularity data for each region is calculated. In addition, since the first selecting operation and the second selecting operation are accepted, different weights are assigned between the first selecting operation and the second selecting operation at a time of totalizing. Thus, it is possible to accurately reflect the degree of interest on the calculated degree of popularity. In addition, the degree of popularity is made displayable for a targeted range, such as for each gender and for each generation, and therefore, a degree of popularly is calculated for each gender and for each generation. Furthermore, the number of users who can watch the program is significantly different depending on a time slot, and therefore, a degree of popularity is calculated for each time slot. In addition, in order to clearly represent the difference of the degree of popularity of each program, the degree of popularity is calculated such that it is classified into a plurality of stages. A detailed method of totalizing and calculating the degree of popularity are described later.

A memory area 652 of the data memory area 650 stores program guide data. The program guide data is generated by the above-described program guide distributing program. Additionally, a region-based program guide is generated, and therefore, program guide data by being brought into correspondence with a region ID is stored. As to the program guide data, information on each program (broadcast station, channel, date, broadcast start time, broadcast stop time, broadcasting hours, program name, detailed information, etc.) is stored by being brought into correspondence with a program ID.

A memory area 654 stores result information of each of the game apparatuses 12 which is received by the above-described result receiving program. From the result information, totalizing and calculating the degree of popularity are performed.

A memory area 656 stores degree of popularity data calculated by the above-described degree of popularity calculating program. In this embodiment, degree of popularity data (see FIG. 19) being brought into correspondence with a region ID is stored for each region. As to the degree of popularity data, a level of the degree of popularity of each program is stored by being brought into correspondence with a program ID.

The program guide displaying application is started up by selecting a button or an icon for instructing the application from the menu screen of the game apparatus 12, for example. When the application is started up, a program guide with the date and the time slot corresponding to the current date and time is displayed. It should be noted that at the first start up, an initial setting is performed before the program guide is displayed. On the program guide screen, the user can change a date and a time slot to be displayed by operating the controller 22, and select desired program information from the program guide, see detailed information, make marking the same, and so forth.

FIG. 13 shows one example of a screen on which a program guide is displayed. At the center of the screen, the program guide is displayed. The program guide is formed in a matrix manner by taking a vertical axis as a broadcast station axis, and a lateral axis as a time axis. More specifically, the time axis for representing a broadcast time is displayed at the upper end of the program guide. The background color of the display field of the time is color-coded for each time slot to help the user watch it. Here, in this embodiment, the time slot is defined by dividing 24 hours (one day) into five periods including single 4 hours in prime time and four 5 hours, that is, the respective time slots of a day are 4:00-8:00, 9:00-13:00, 14:00-18:00, 19:00-22:00 (golden time or prime time), 23:00-3:00. It should be noted that how the time slot is divided may be changed as necessary.

In the program guide, lines or bands of the respective broadcast stations are arranged below the time axis for placing program information to be broadcasted. At the left end of each line, a broadcast station name and a channel number are displayed, and at the right thereof, respective program information of the broadcast station and the channel are arranged in chronological order. The field of each program information is enclosed by a frame having a width corresponding to the length of the broadcasting hour, and within the frame, the program name of the program information is displayed. The letters of the program name is abbreviated depending on the size of the frame as required.

Also, as understood from FIG. 13, the program information of only a part of the broadcast stations and the time slots are displayed in the program guide, but by performing a predetermined operation with the controller 22 to scroll the program guide up and down or from side to side, program information of other broadcast stations or other time slots can be displayed.

Furthermore, a pointer 700 for indicating an instructed position by the controller 22 is displayed on the screen. The display position of the pointer 700 is moved in accordance with the instructed position by the controller 22.

At the upper end of the screen, information relating to the date of the program guide which is being displayed is displayed, and various buttons 702, 704, 706, 708 and 710 are provided. The information relating to the date, at the left end represents the date of the program guide which is being displayed with reference to the current date. In FIG. 13, this is indicated by “4 days after”, and it is clear from this that the program guide which is being displayed is that to be displayed 4 days after.

The button 702 is a button for designating a date of the program guide to be displayed, and a date and a day of the week of the program guide are written on the button 702. For example, when the A button 26d is pushed in a state that the pointer 700 is placed on the button 702, the date sets forward by one day, and when the B trigger switch 26i is pushed in the same state, the date sets backward by one day.

The button 704 is for a button for designating a display state of the program guide. In general, the button allows the user to designate a normal state in which a program guide is displayed, a state in which the program selected by the user is displayed on the program guide, and a state in which the degree of popularity is displayed on the program guide. In FIG. 13, on the button 704, “NONE” is written, and this means the normal state. For example, every time that the A button 26d is pushed in a state that the pointer 700 is placed on the button 704, the display state is switched in order.

The button 706 is a button for searching a program. For example, when the A button 26d is pushed in a state that the pointer 700 is placed on the button 706, a search screen is displayed to allow for a keyword search and a genre search.

The button 708 is a button for performing various settings. For example, items set at the initial setting, such as a region, user information, a targeted range, etc. can be changed. For example, when the A button 26d is pushed in a state that the pointer 700 is placed on the button 708, a setting screen is displayed to allow the user to perform various settings.

The button 710 is a button for returning to the menu screen of the game apparatus 12. When the button 710 is selected, that is, when the A button 26d is pushed in a state that the pointer 700 is placed on the button 710, the program guide displaying application is ended to thereby display the menu screen.

At the lower end of the screen, a mark icon (inclusively denoted by the reference numeral “712”) and a clock 714 are displayed. The mark icon 712 is an icon used for marking a program by the user (that is, selection of a program the user wants to watch by the second selecting operation), and the mark icon 712 of the respective users registered in the game apparatus 12 are displayed. Additionally, the mark icon 712 is represented by a portrait for allowing identification of the user, for example, and such a selection of the mark icon 712 by each user can be performed at the initial setting. The clock 714 displays a current time. The information on the current time is obtained from the ROM/RTC 48.

Furthermore, in this embodiment, as shown in FIG. 14, the program guide can be displayed by a 3-D image. In the 3-D display, a program guide of one day is formed by a sheet of plate or a rectangular parallelepiped. For example, by displaying seven sheets of plates in layers, program guides of one week can be represented. Since the respective plates are layered, the program information is displayed on the foremost plate. In FIG. 14, however, only the frames of the fields of the respective program information are displayed. Moreover, at the left edge of each plate, a tub (inclusively denoted by the reference numeral “716”) is provided, and by selecting the tub 716 with the pointer 700, a program guide with a date corresponding to the tub 716 can be displayed at the forefront. Also, by operating the button 702, the program guide to be displayed at the forefront can be switched.

Additionally, by pushing the A button 26 or the 1 button 26b at a predetermined area, for example, the 2-D display as shown in FIG. 13 and the 3-D display as shown in FIG. 14 can be switched. Alternatively, setting with the button 708 may instruct the switch.

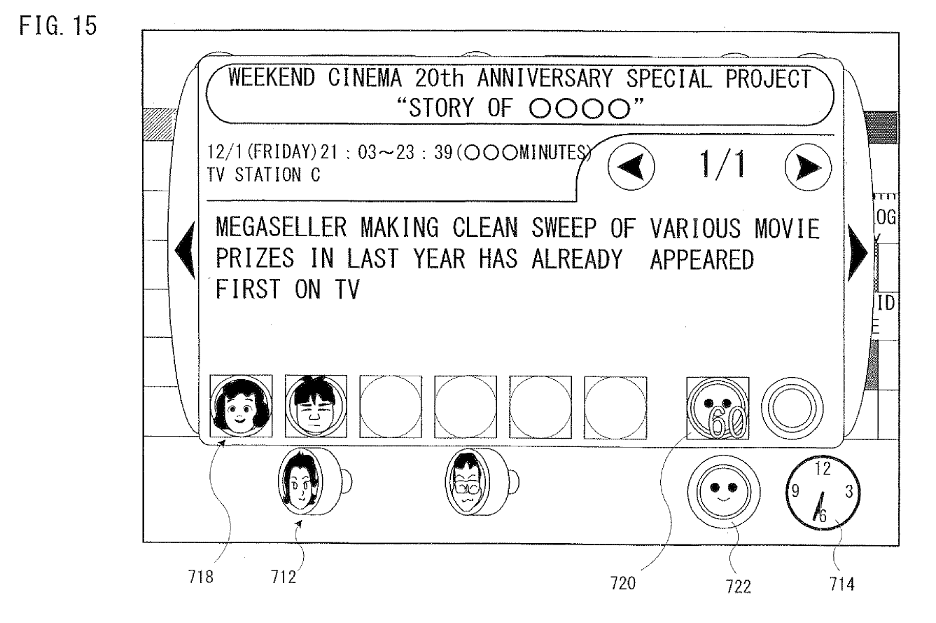

The user can display details of the program information by pushing the A button 26d in a state that a field of the desired program information is instructed with the pointer 700 in the 2-D program guide. When the first selecting operation is performed, a detailed screen is displayed on the program guide as shown in FIG. 15, for example. On the detailed screen, a program name, a broadcasting date, a broadcasting hour, a broadcast station name, and detailed information, and etc. are displayed.

The operation of displaying the detailed screen is the first selecting operation as described above. In a case that the A button 26d is pushed in a state that the display position of the pointer 700 is included in the display area of the program guide, it is determined that the first selecting operation is performed to designate a program ID of the selected program information on the basis of the display position of the pointer 700 and the display position of each program information. Then, program selecting data corresponding to the program ID is generated in the memory area 512, and its detail flag is turned on.

At the lower end of the detailed screen, a plurality of frames (inclusively denoted by the reference numeral “718”) for allowing each user to mark the program information are provided. Each user can mark the program information, that is, select the program information as a program that he or she wants to watch by moving his or her own mark icon 712 to the display position of the frame 718.

For example, with a drag-and-drop operation, the mark icon 712 can be placed at the frame 718. More specifically, by simultaneously pushing the A button 26d and the B trigger switch 26i in a state that the pointer 700 moves at the mark icon 712, the mark icon 712 is made movable in accordance with the instructed position. In addition, by moving the instructed position to the frame 718 by the controller 22 in a state that the A button 26d and the B trigger switch 26i are kept pushed, the mark icon 712 can be moved at the frame 718. Then, by releasing the A button 26d and the B trigger switch 26i, the mark icon 712 can be placed at the frame 718.

This marking operation is the second selecting operation as described above. In a case that the mark icon 712 is placed at the frame 718 on the detailed screen, it is determined that the second selecting operation is performed. A user ID of the user who marks the program is specified from the mark icon 712, and stored in the program selecting data corresponding to the program ID.

Moreover, in the 3-D program guide, a selecting operation as in the selecting operation in the 2-D program guide may be made possible.

If the detailed screen of the program information being marked is opened thereafter, the detailed screen in a state that the mark icon 712 of the user having marked the program information is arranged at the frame 718 is displayed. Accordingly, the mark icon 712 of the detailed screen can show which user out of the registered users (family) selects and registers the program information as a program that he or she wants to watch.

Additionally, the detailed screen is provided with a frame 720 other than the frame 718 for allowing a family member who has already been registered as a user in the game apparatus 12 to perform marking. The frame 720 is for displaying information relating to a marking by a user of another game apparatus 12 which has been registered in advance, that is, the frame 720 can inform the user of a condition of the marking by the friend with respect to the program information. In the frame 720, the number of users each marking the program information out of the users of other game apparatuses 12 who have already been registered is displayed. In addition, at the lower end of the program guide, a button 722 is displayed. When the button 722 is selected, a screen showing a list (friend list) of users of other game apparatuses 12 who have already been registered, for example, is displayed. On this screen, icons representing the respective users are displayed, but for the user who has already been registered, its mark icon is displayed. Accordingly, it is possible to know which friend marked the program.

It should be noted that the game apparatus 12 can transmit and receive data with other game apparatuses 12 who have already been registered, as shown in another embodiment described later. Accordingly, in a case that the second selecting operation for marking is performed, by transmitting data including an user ID associated to the program ID like program selecting data to another game apparatus 12 which has already been registered, the another game apparatus 12 can display the content of the frame 720 and the screen to be opened with the button 722 as described above.

Also, the second selecting operation for marking may be performed on the screen of the program guide as well as the detailed screen. More specifically, similar to the above-described detailed screen, by moving the mark icon 712 to a field of desired program information of the program guide with a drag-and-drop operation, for example, it is possible to select the program information as a program that the user wants to watch.

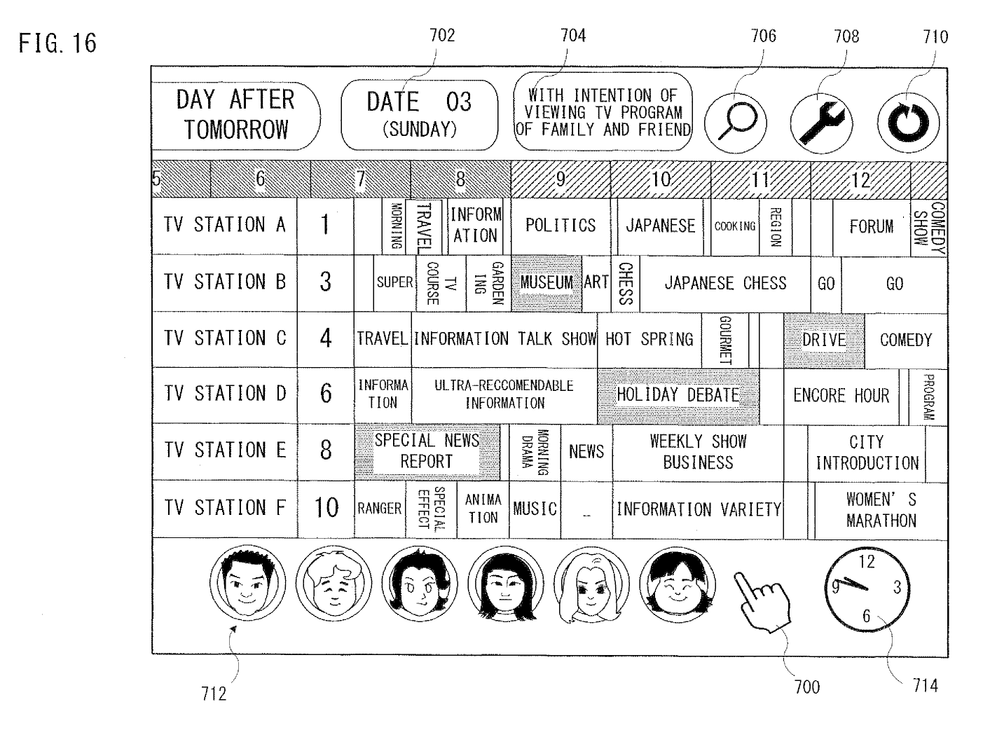

In a case that the marking is thus performed, the result can be displayed on the screen of the program guide. More specifically, by pushing the button 704, the program guide is switched to a state in which a program selected by the user is displayed. FIG. 16 shows one example of a screen of the program guide which is switched to the state in which a program selected by the user is displayed. On the button 704, “with the intention of viewing the program selected by his or her own family and friends will” is written, and this shows the state in which a program selected by the users is displayed. In the program guide in this state, the background color of the field of the program information which is marked is changed to the color the same as the mark icon 712 of the user. Accordingly, it is possible to easily know which user has marked the program information.

Although not shown in FIG. 16, in the program guide in this state, a program selected by a fried is also displayable. If data relating to the selection result from another game apparatus 12 has already been fetched, the button 722 as shown in FIG. 15 is displayed at the left of the clock 714, and the background color of the field of the program information selected by the user of this another game apparatuses 12 is changed to the color the same as the button 722.

Here, in a case that the same program information is selected by a plurality of users, the background color of the field of the program information may be changed to a specific color. By opening the detailed screen, it is possible to know users having marked the program information. Alternatively, the field may be divided into a plurality of areas, and the plurality of areas each of which is changed in a corresponding color to each of the plurality of users.

The result information indicating a result of a selection in each of the game apparatuses 12 is transmitted to the distribution server 102. The distribution server 102 performs totalization processing of the received result information to calculate degree of popularity data.

In this embodiment, the totalization is performed for each region. It may be possible to calculate a degree of popularity by totalizing not for each region hut for all the regions. However, if the degree of popularity is calculated not for each region but for all the regions, there occurs problems that the degree of popularity of a major program broadcasted at the all regions is generally apt to be high, and a degree of popularity of a program which is broadcasted at only a specific region but has a high degree of popularity in that region is generally apt to be low. However, if the degree of popularity is calculated for each region, such a problem is solved, and it is possible to display more accurately a degree of popularity of a program at each region.

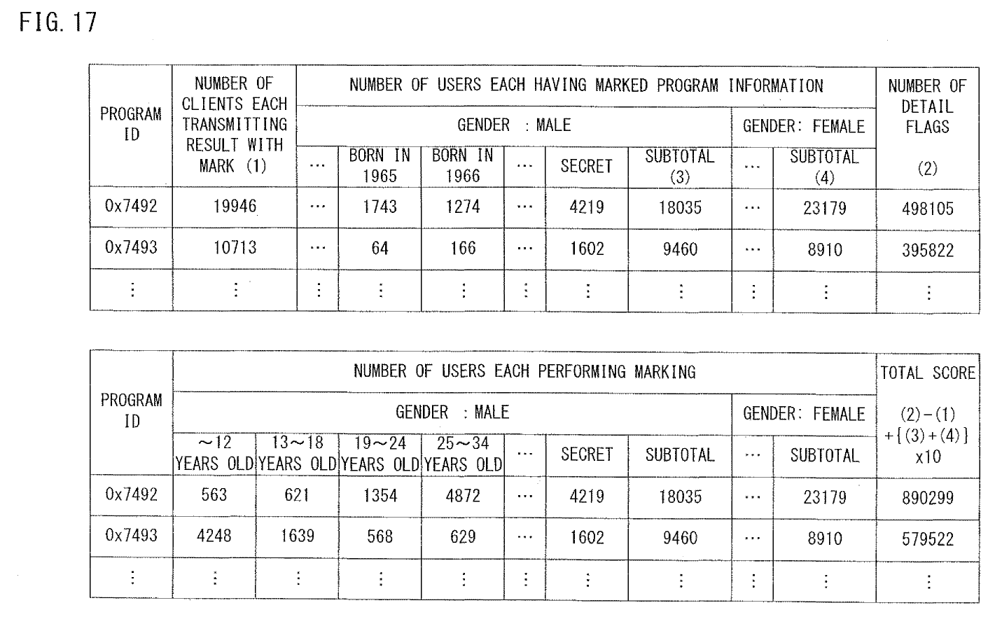

More specifically, a totalization table shown in FIG. 17 is produced on a regional basis. That is, as shown in the table on the upper side shown in FIG. 17, as to each program information, the number of clients each having transmitted a result with mark, the number of users who have marked the program information, and the number of detail flags are totalized. The number of clients each having transmitted a result with mark is the number of game apparatuses 12 each having transmitted the result information in which the mark total value is not 0. Furthermore, the number of users each having marked the program information is totalized on a gender basis and a year of birth basis. In addition, the number of detail flags is totalized when the detail flag is turned on in the received result information.

Next, as shown in the table on the lower side shown in FIG. 17, as to each program information, the number of users who have marked the program information is totalized again on a gender basis and a generation basis, and the total score is calculated. The generation is classified into 12 years old and under, 13-18 years old, 19-24 years old, 24-34 years old, 35-44 years old, 45-54 years old, and 55 years old and over, for example. Each of the number of users who have marked the program information on a gender basis and on a generation basis indicates the degree of popularity of each program information on a gender basis and a generation basis. By such a totalization, it is possible to easily know a difference in the degree of popularity of a program between males and females and a difference in the degree of popularity for each generation or each age.

The total score shows a comprehensive evaluation of each program information, that is, shows an overall degree of popularity targeted to all the generations and both of the genders. In this embodiment, the total score shows a comprehensive degree of interests in which a second selecting operation for marking and a first selecting operation for displaying detailed information are combined.

More specifically, the total score is calculated by assigning different weights to the number of game apparatuses 12 on which only the first selecting operation is performed and the number of users who perform the second selecting operation and adding the same. Here, the number of game apparatuses 12 on which only the first selecting operation is performed is obtained from the difference between the number of detail flags and the number of clients who send a result with mark. Furthermore, the number of users who perform the second selecting operation is obtained from the sum of the subtotal of the male users who have marked the program information and the subtotal of the female users who have marked the program information. The number of users who perform the second selecting operation is applied with a weight larger than that applied to the number of game apparatuses 12 which performs only the first selecting operation. For example, the weighting factor for the first selecting operation is set 1, and the weighting factor for the second selecting operation is set to 10.

Thus, it is possible to calculate a degree of popularity by applying different weights depending on the kind of a selecting operation by the user. There is a definite difference in the degree of interest in a program by the user between the first selecting operation for viewing the detailed information and the second selecting operation for performing marking. Accordingly, this makes it possible to calculate a degree of popularity on which a degree of interest by the user is accurately reflected.

Then, in this embodiment, each program is classified into five stages from the totalization result, that is, the degree of popularity of each program is represented by 1-5 in steps. This makes it possible to intelligibly illustrate the degree of popularity of each program.

Furthermore, in dividing the degree of popularity into steps, the totalization results are compared for each time slot to calculate a degree of popularity for each time slot in this embodiment. The degree of popularity may be calculated for all the time slots without being divided for each time slot. If the degree of popularity is calculated not for each time slot but for all the time slots, the degree of popularity of a program at a time slot of a prime time which relatively a number of users who watch is generally apt to be high while programs at the other time slots, even if they are high in degree of popularity at these time slots, may be relatively low in comparison with the program at the prime time (the number of users is low) and may relatively be displayed in low. However, if the degree of popularity is calculated for each time slot, such a problem is solved, capable of accurately displaying a degree of popularity of a program for each time slot.

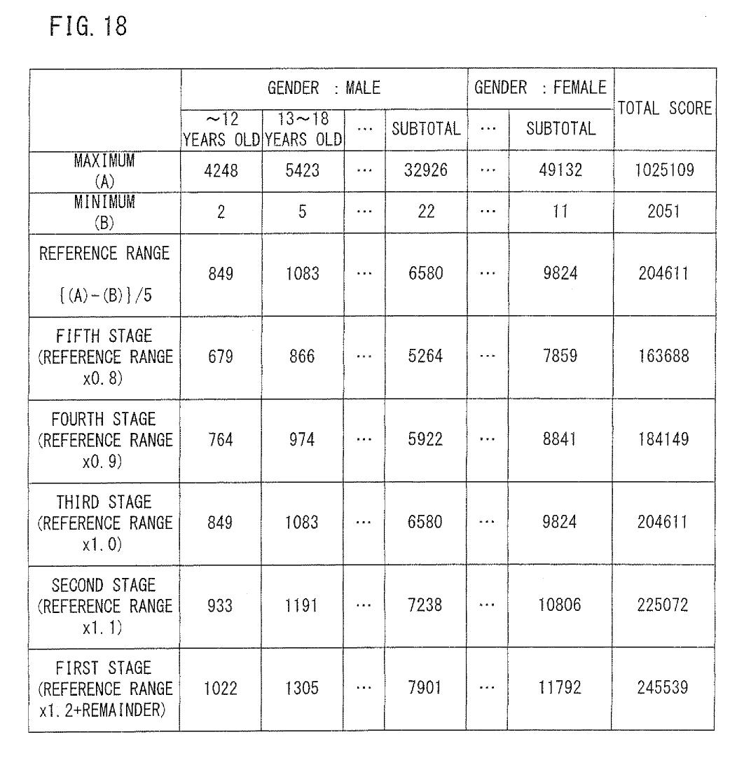

FIG. 18 shows an outline of a method of classifying or dividing a degree of popularity obtained by a comparison for each time slot. FIG. 18 shows a case that a classification of the degree of popularity is performed on a gender-basis, a generation basis and an entire basis from the totalization result on a gender-basis and a generation-basis and the total score shown on the lower side of FIG. 17. However, by utilizing the result obtained by totalizing the values for males and females, classification of the degree of popularity not on a gender-basis but on a generation-basis can be performed. Furthermore, classification of a degree of popularity on a gender-basis and on an age-basis can be performed from the totalization result on a gender-basis and on an age-basis shown on the upper side of FIG. 17.

More specifically, first, totalization results of respective programs are compared for each time slot to detect a maximum value and a minimum value. Here, a time slot to which each program belongs is decided by where the start time of each program is included, for example. However, how to section the time slots may be changed as necessary. For example, in a case that broadcasting hours of a program extends over a plurality of time slots, the time slot where the broadcasting hours extends longer may be selected.

Next, in order to classify into five stages or steps between the maximum value and the minimum value, by dividing the difference between the maximum value and the minimum value by five, a reference range is calculated. Then, from the reference range, a range of each of the levels of the degree of popularity is calculated. In this embodiment, each range is set such that higher the level is, the narrower the range is. For example, the range at the fifth stage is set to be 20% less of the reference range, the range at the fourth stage is set to be 10% less of the reference range, the range at the third stage is set to be identical with the reference range, the range at the third stage is set to be 10% more of the reference range, and the range at the first stage is set to be 20% more of the reference range.

Assuming that the persons who are male as a gender and 12 years old and under as a generation are targeted. In FIG. 18, the maximum value is 4248, the minimum value is 2, and the reference range is thus 849 obtained by dividing the difference between 4248 and 2 by 5. It should be noted that the fractional part after the decimal point is omitted, and the remainder is included in the first stage. The range at the fifth stage is 679 obtained by multiplying the reference range by 0.8, the range at the fourth stage is 764 obtained by multiplying the reference range by 0.9, the range at the third stage is 849 obtained by multiplying the reference range by 1.0, the range at the second stage is 933 obtained by multiplying the reference range by 1.1, and the range at the first stage is 1022 obtained by multiplying the reference range, that is, 849 by 1.2 and being added with the remainder. That is, when the persons who are male as a gender and 12 years old and under as a generation are targeted, if the totalization result of the program information is within the range of 3570-4248, the level of the degree of popularity of the program information is set to 5, and if the totalization result is within the range of 2806-3569, the level of the degree of popularity is set to 4, if the totalization result is within the range of 1957-2805, the level of the degree of popularity is set to 3, if the totalization result is within the range of 1024-1956, the level of the degree of popularity is set to 2, and if the totalization result is within the range of 2-1023, the level of the degree of popularity is set to 1.

As the level of the degree of popularity is high, the range is narrow, so that only the programs which are selected by a number of users and are actually popular are applied with a high evaluation, and can be displayed as a program with high popularity.

Additionally, in the above-described embodiment, the range of each level or stage of the degree of popularity is calculated by utilizing the difference between the maximum value and the minimum value, but the minimum value may not to be used. That is, the minimum value shall be 0, and the maximum value is divided by 5 to calculate a reference range to calculate a range at each level of the degree of popularity.

It should be noted that the method of classification or division into levels or stages may be changed as necessary. As one example, as a method of classification into five, the total number of programs may be merely divided into five. For example, if the total number of programs is ranked from 1-100, they are classified into five stages in the order of magnitude of the totalized value. For example, the fifth stage is first place to 20th place, the fourth stage is 21th place to 40th place, the third stage is 41th place to 60th place, the second stage is 61th place to 80th place, and the first stage is 81th place to 100th place. Furthermore, if there is a remainder, it shall be added to the first stage. For example, if the total number of programs is 103, 81th place to 103th place shall be the first stage.

The aforementioned classification into levels is performed on the totalization results and the total scores on a gender-basis and a generation-basis to calculate a level of the degree of popularity of each program information and thus create the degree of popularity data shown in FIG. 19. In this embodiment, the totalization is performed for each region, and therefore, degree of popularity data for each region is generated. When a request is issued from each game apparatus, the distribution server 102 transmits degree of popularity data corresponding to a region ID of each game apparatus 12.

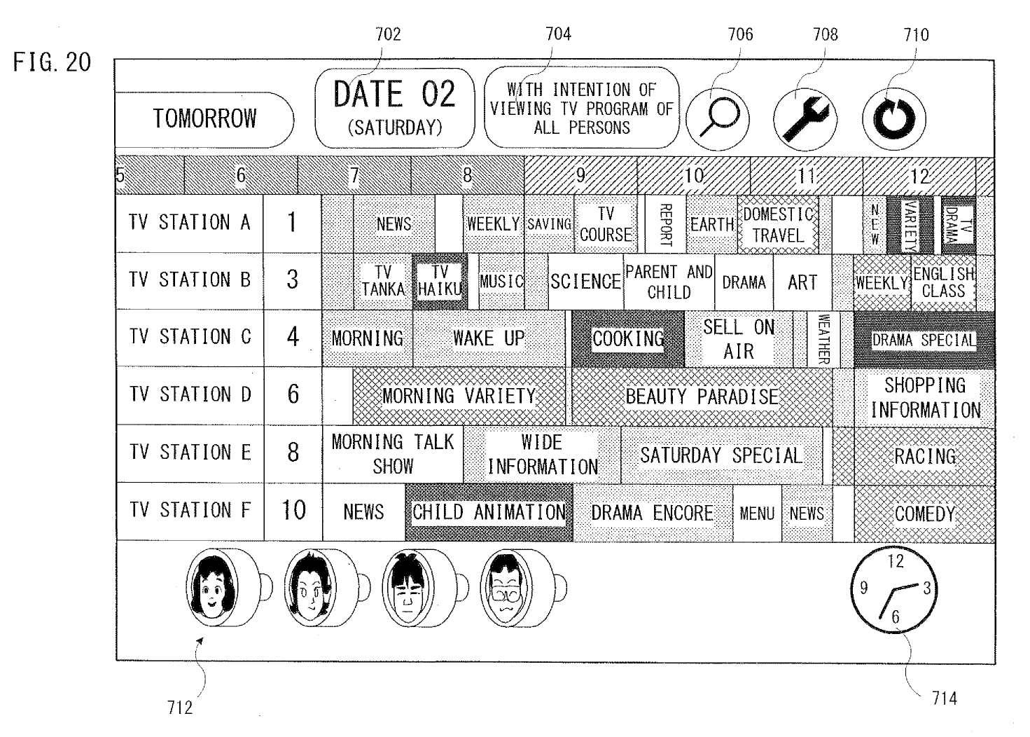

The game apparatus 12 which has received the degree of popularity data can display a program guide with a degree of popularity shown. FIG. 20 shows one example a program guide in a state that the degree of popularity is displayed. By pushing the button 704, the display state of the program guide can be switched to the state that the degree of popularity is displayed. In FIG. 20, “with the intention of viewing TV program of all persons” is described on the button 704, and this means that this is the program guide in a state the degree of popularity is displayed.

In the program guide in a state that the degree of popularity is displayed, a display manner of each program information is changed depending on the level of the degree of popularity. The display manner of each program information displayed in a matrix is changed depending on the degree of popularity, and therefore, the user can intuitively grasp the degree of popularity of each program on the program guide. Specifically, it is possible to easily grasp a trend, such as which time slot and which broadcast station has a lot of highly favored programs.

In addition, in this embodiment, a background color of a field of each program information is made dark depending on the level of the degree of popularity, and therefore, it is possible to visually grasp the degree of popularity of each program information.

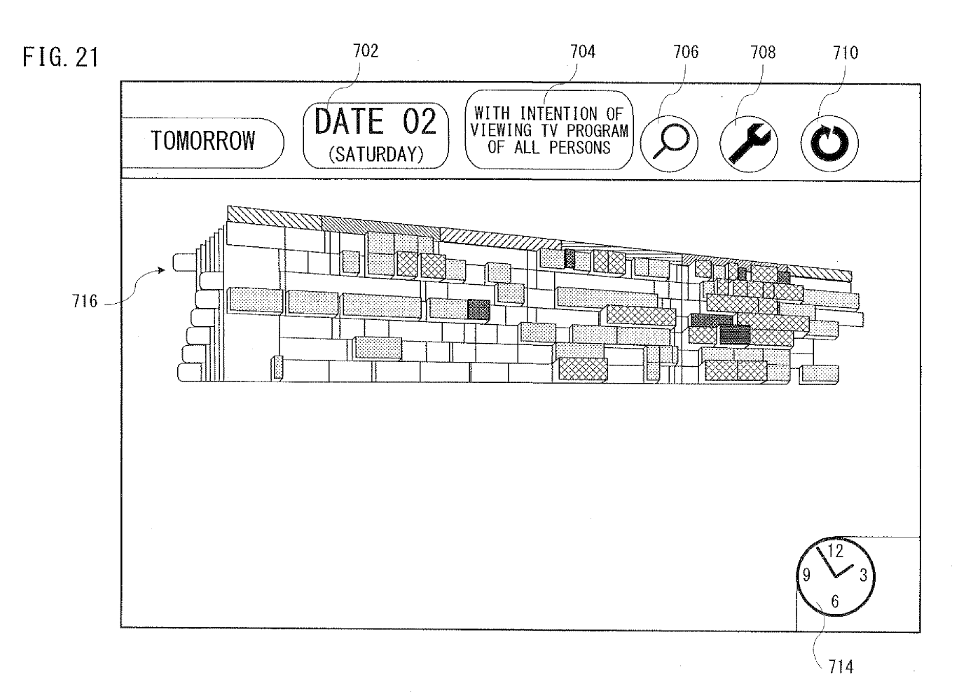

Furthermore, the degree of popularity can be displayed by the 3-D program guide as well as the 2-D program guide as shown in FIG. 20. FIG. 21 shows one example of the 3-D program guide in a state that the degree of popularity is displayed. In also the 3-D display of the program guide, the background color of a field of each program information is made dark depending on the level of the degree of popularity as in the 2-D display.

In addition, in a case of the 3-D program guide, the direction orthogonal to both of the broadcast station axis and the time axis of the program guide can be represented, and therefore, a height direction of a field of each program information can be set to the direction. Here, in this embodiment, the height of the field of each program information is changed depending on the degree of popularity. The field of each program information is displayed in a protruded manner depending on the degree of popularity, so that such representation of the height allows the user to visually and easily gasp a degree of popularity of each program information.

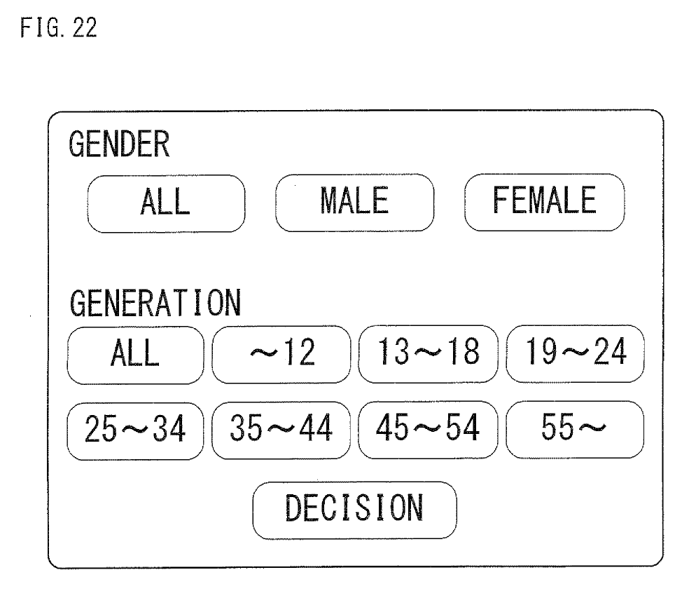

As described above, in this embodiment, degree of popularities on a gender-basis and on a generation-basis are calculated, and this makes it possible to display the degree of popularity targeted at a desired gender and a desired generation in the program guide. The setting of the targeted range for displaying the degree of popularity can be performed by an initial setting, a setting by the button 708, and the like. FIG. 22 shows one example of a screen for setting of the targeted range. The gender can be selected from all, males and females. The generation can be selected from all, 12 years old and under, 13-18 years old, 19-24 years old, 25-34 years old, 35-44 years old, 45-54 years old, 55 years old and over. Each item is formed by a button, and by selecting a desired gender and a desired generation with the pointer 700 and then selecting a decision button, the targeted range can be set. Additionally, if “all” in the items of gender and “all” in the items of generation are selected, the display is performed on the basis of the level of the degree of popularity of the total score in this embodiment.

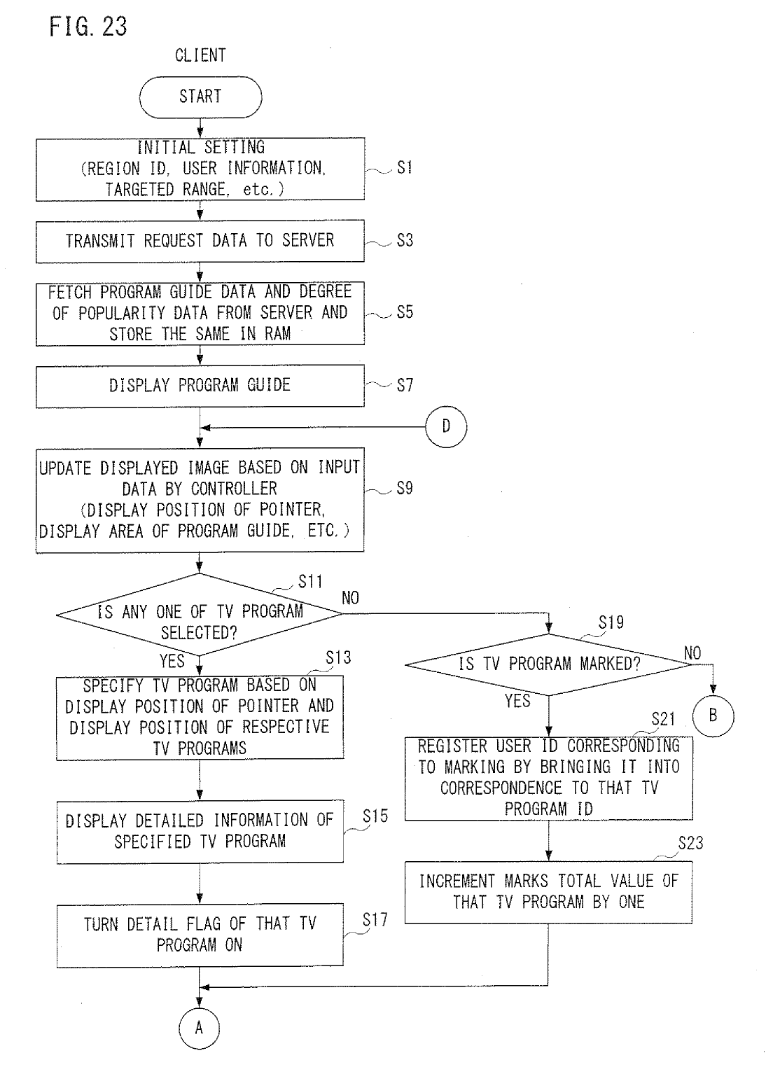

FIG. 23 to FIG. 25 show one example of an operation for a degree of popularity displaying processing of the game apparatus 12. When the program guide displaying application is started, the CPU 40 executes an initial setting in a step S1. At a first start-up, a region ID (region where the user lives), user information (year of birth, gender, mark icon 712), a targeted range (generation, gender) for displaying a degree of popularity, etc. are set by an input by the user, and stored in each of the memory areas 502, 504, 506, etc. of the external memory 46, respectively. The set information is also stored in the flash memory 44, and at a second start-up onward, each set information is read from the flash memory 44 to the external memory 46.

Next, in a step S3, the CPU 40 transmits request data to the distribution server 102 on the network 104 via the input-output processor 42a, the radio communication module 50, etc. The request data is a command for requesting transmission of program guide data and degree of popularity data, and includes a region ID. In response to the request, program guide data and degree of popularity data corresponding to the region ID are transmitted to the game apparatus 12 from the distribution server 102.

Thus, in a step S5, the CPU 40 fetches the program guide data and the degree of popularity data from the distribution server 102 via the input-output processor 42a and the radio communication module 50, etc. and stores the same in the memory areas 508 and 510 of the RAM (external memory 46).

Succeedingly, in a step S7, the CPU 40 displays the program guide on the monitor 34. More specifically, the CPU 40 generates data for displaying the screen for program guide in the VRAM 42d by utilizing the GPU 42b, and displays the screen for program guide on the monitor 34 via the AV IC 56 and the AV connector 58, etc. It should be noted that the screen for program guide is generated on the basis of the program guide data, the user information and the image data, etc. Since the 2-D display of the program guide is set as a default, for example, a 2-D program guide is displayed as shown in FIG. 13. In the 2-D program guide, program information at the date and the time slot corresponding to the current date and time fetched from the ROM/RTC 48 is selected and displayed within the display area. The width of the field of each program information is set on the basis of broadcasting hours of each program, and if the broadcasting hour is longer than a fixed time period, the program name is displayed by the number of letters corresponding to the width of the frame. Furthermore, the mark icon 712 of each user is displayed on the basis of the user information of the memory area 504.

In a step S9, the CPU 40 performs updating processing of the displayed image by utilizing the GPU 42b on the basis of the input data of the controller 22. Noted that the input data is received at regular time intervals by the input-output processor 42a and the radio controller module 52, etc. so as to be stored in a buffer area of the internal memory 42e or the external memory 46. The CPU 40 executes processing by reading the input data from the buffer area. For example, in a case that the instructed position is detected, the display position of the pointer 700 is updated on the basis of the instructed position. Furthermore, a display area (date, time slot, etc.) of the program guide is changed in accordance with a scrolling operation and a selecting operation of the button 702, etc. on the screen by the input means 26. In addition, in response to a predetermined input, the program guide is switched between the 2-D display and the 3-D display. For example, in a case of the 3-D program guide shown in FIG. 14, seven sheets of plates are layered in the virtual 3-D space, and one day's program guide at the date corresponding to the current date is displayed on the foremost plate. It should be noted that the 3-D program guide of this embodiment only shows the respective frames of the programs each ranging from the start time to the stop time, and not displaying a program name.

In addition, the user can watch detailed information and mark a program by performing a predetermined operation on the program guide as described above. The result of selecting the program is transmitted to the distribution server 102. Furthermore, by performing a predetermined operation, it is possible to display a degree of popularity of each program in the program guide on the basis of the degree of popularity data totalized and distributed by the distribution server 102.

More specifically, in a step S11, the CPU 40 determines whether or not any one of the programs is selected on the basis of the input data, the display position data of the program guide, and etc. For example, it is determined whether or not the coordinates of the display position of the pointer 700 when the A button 26d is pushed are within the display area of the program guide. If “YES” in the step S11, the CPU 40 specifies the selected program on the basis of the display position of the pointer 700 and the display position of the respective programs in a step S13. More specifically, the coordinates of the display position of the pointer 700 and the coordinates of the display positions of the respective programs in the program guide are compared to specify a program ID of a program including the coordinates of the display position of the pointer 700.

In a succeeding step S15, the CPU 40 displays the detailed information of the specified program. More specifically, the CPU 40 generates data to display a detailed screen (see FIG. 15) of the specified program in the VRAM 42d by utilizing the GPU 42b. The detailed information corresponding to the specified program ID is read from the program guide data of the memory area 508. Furthermore, if with reference to the program selecting data of the memory area 512, the user ID of the user who marks the program of the program ID has already been stored, the mark icon 712 corresponding to the user ID is arranged at the frame 718 of the detailed screen.

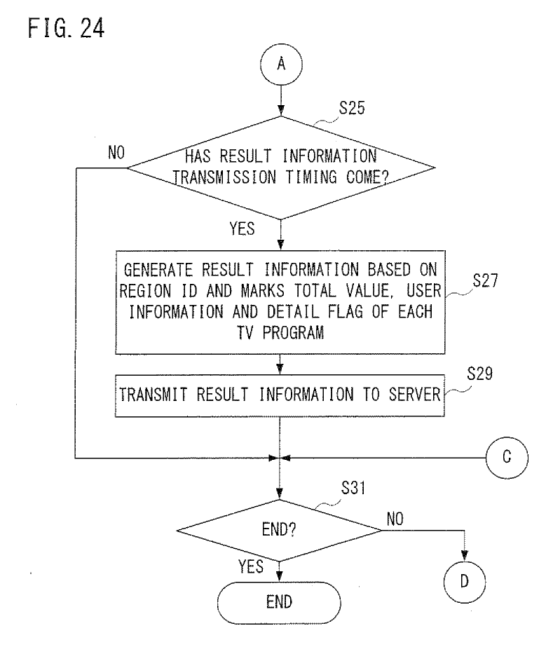

Then, in a step S17, the CPU 40 turns the detail flag of the specified program on. More specifically, in a case that the program selecting data of the program ID is not generated in the memory area 512, the program selecting data of the program ID is generated, and the detail flag is turned on. After completion of the step S17, the process proceeds to a step S25 shown in FIG. 24.

Alternatively, if “NO” in the step S11, the CPU 40 determines whether or not marking is made in a step S19. For example, whether or not a drag-and-drop operation of the mark icon 712 is performed on the display area of the frame 718 of the detailed screen is determined on the basis of the input data and the display position data of the mark icon 712 and the frame 718, and etc.

If “YES” in the step S19, the CPU 40 registers the user ID corresponding to the marking by bringing it into correspondence to program ID in a step S21. More specifically, a user ID of a user corresponding to the operated mark icon 712 is specified on the basis of the user information of the memory area 504, and the user ID is stored in the program selecting data memory area 512 as a user ID who marks the program with the program ID.

In a succeeding step S23, the CPU 40 increments the mark total value of the program by one. More specifically, the mark total value corresponding to the program ID stored in the program selecting data memory area 512 is added by one to thereby calculate the number of users who marks the program. After completion of the step S23, the processing proceeds to the step S25 shown in FIG. 24.

In the step S25 shown in FIG. 24, the CPU 40 determines whether or not a result information transmission timing has come. The result information transmission timing is set as appropriate. For example, if the result information is set at fixed time intervals, it is determined whether or not a fixed time elapses from the previous transmission. Furthermore, the transmission timing may be set at a predetermined hour of day or when the program guide application is to be ended or the like.

If “YES” in the step S25, the CPU 40 generates result information in the memory area 514 on the basis of a region ID, and a mark total value, user information, a detail flag of each program, etc. in a step S27. The result information includes, as shown in FIG. 10, not only a transmission source ID and a region ID but also the mark total value being brought into correspondence with a program ID of the selected program, a year of birth and a gender of the user who mark the program, a detail flag, etc.

In a succeeding step S29, the CPU 40 transmits the result information to the distribution server 102 via the input-output processor 42a, the radio communication module 50, etc. Thus, the result of the selection, such as watching the detailed information and marking a program on the program guide by each user is transmitted to the distribution server 102. On the other hand, if “NO” in the step S25, the process directly proceeds to a step S31.

Then, in the step S31, the CPU 40 determines whether or not the program guide application is to be ended. More specifically, it is determined whether or not the end of the application is instructed by the user on the basis of the input data and the displayed position data of the button 710. If “NO” in the step S31, the process returns to the step S9 shown in FIG. 23 while if “YES”, the program guide displaying application is ended.

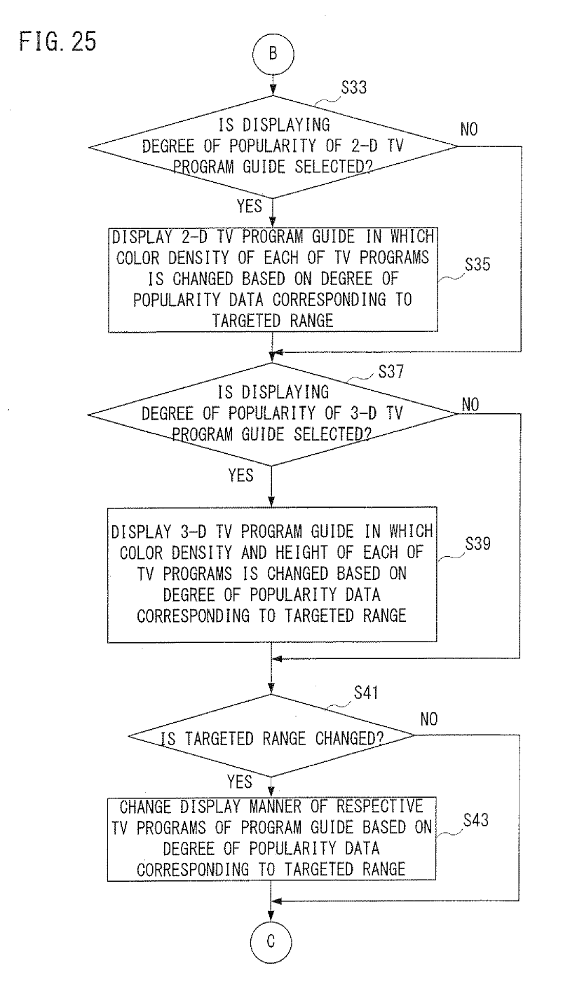

Furthermore, if “NO” in the step S19 in FIG. 23, the process proceeds to a step S33 in FIG. 25. In the step S33, the CPU 40 determines whether or not displaying the degree of popularity of the 2-D program guide is selected. More specifically, it is determined whether or not a state that degree of popularity is displayed is selected in response to an operation performed on the button 704 when the 2-D program guide is displayed on the basis of the input data and the displayed position data of the button 704, etc. Or, it is determined whether or not switching operation from the 3-D program guide on which the degree of popularity is being displayed to the 2-D program guide is performed on the basis of the input data, etc.

If “YES” in the step S33, the CPU 40 displays the 2-D program guide in which the color density of the respective program are changed on the basis of the degree of popularity data corresponding to the targeted range in a step S35. More specifically, in the degree of popularity data, the degree of popularity on a gender-basis and on a generation-basis is stored as shown in FIG. 19, and therefore, degree of popularity data corresponding to a targeted range (generation, gender) of the memory area 506 is read from the memory area 510. Then, on the basis of the display manner data (FIG. 11) of the memory area 516, the color density corresponding to the level of the degree of popularity of each program is decided. The CPU 40 changes the display manner (color density of the field of the program information in this embodiment) of each program information in the program guide depending on the level of the degree of popularity by utilizing the GPU 42b, and generates data for displaying the program guide in the VRAM 42d. Thus, as shown in FIG. 20, the 2-D program guide in which the color of the background of each program information is changed in density depending on each degree of popularity is displayed on the monitor 34. Since the degree of popularity is represented by gradual difference in color density of the program guide, it is possible to allow the user to intuitively and easily know the degree of popularity of each program information. Alternatively, if “NO” in the step S33, the process directly proceeds to a step S37.

In the step S37, the CPU 40 determines whether or not displaying the degree of popularity of the 3-D program guide is selected. More specifically, it is determined whether or not an operation of switching from the 2-D program guide on which degree of popularity is being displayed to the 3-D program guide is performed on the basis of the input data and the displayed position data of the program guide, etc. For example, it is determined whether or not the A button 26d is pushed in a state that the display area of the 2-D program guide with the degree of popularity displayed is instructed by the pointer 700, or it is determined whether or not a predetermined button out of the input means 26 is operated.

If “YES” in the step S37, the CPU 40 displays the 3-D program guide in which a color density and a height of each program is changed on the basis of the degree of popularity data corresponding to the targeted range in a step S39. More specifically, the color density and height corresponding to the level of the degree of popularity of each program are decided on the basis of the display manner data of the memory area 516. The CPU 40 changes the display manner (color density and height of the field of the program information in this embodiment) of each program information in the 3-D program guide depending on the level of the degree of popularity by utilizing the GPU 42b, and generates data for displaying the 3-D program guide in the VRAM 42d. Accordingly, as shown in FIG. 21, the 3-D program guide in which the background color of the field of each program information in the program guide on the foremost plate has a color density corresponding to each level of the degree of popularity, and the height takes a height corresponding to each level of the degree of popularity is displayed on the monitor 34. Thus, since the degree of popularity is represented by a gradual difference in color density of the program guide and the height, it is possible to allow the user to intuitively and easily understand the degree of popularity of each program information. Alternatively, if “NO” in the step S37, the process directly proceeds to a step S41.

In the step S41, the CPU 40 determines whether or not the targeted range is changed. More specifically, it is determined whether or not a gender and a generation are changed on the basis of the input data, the displayed position data of the button 708, the targeted range data, etc. by the setting of the targeted range when the degree of popularity is displayed. As to the setting of the targeted range included in the setting by the button 708, the screen shown in FIG. 22 is displayed, and by selecting the respective buttons, the gender and the generation are set, and if any change is required, the targeted range data of the memory area 506 is updated.

If “YES” in the step S41, the CPU 40 changes the display manner of the respective programs of the program guide on the basis of the degree of popularity data corresponding to the targeted range data in a step S43. More specifically, the degree of popularity data corresponding to the changed targeted range (generation, gender) is read from the memory area 510, and the color density corresponding to the level of the degree of popularity of each program is decided on the basis of the display manner data of the memory area 516. In a case of a state that the 3-D program guide is displayed, the height corresponding to the level of the degree of popularity of each program is also decided. Then, the CPU 40 changes the display manner (color density, height) of each program information in the 2-D or 3-D program guide in correspondence to the level of the degree of popularity by utilizing the GPU 42b, and generates data for displaying the program guide in the VRAM 42d. Thus, the 2-D or 3-D program guide which is changed to the display manner corresponding to the degree of popularity of the changed targeted range is displayed on the monitor 34. Alternatively, if “NO” in the step S41, the process directly proceeds to the step S31 show in FIG. 24 described above.

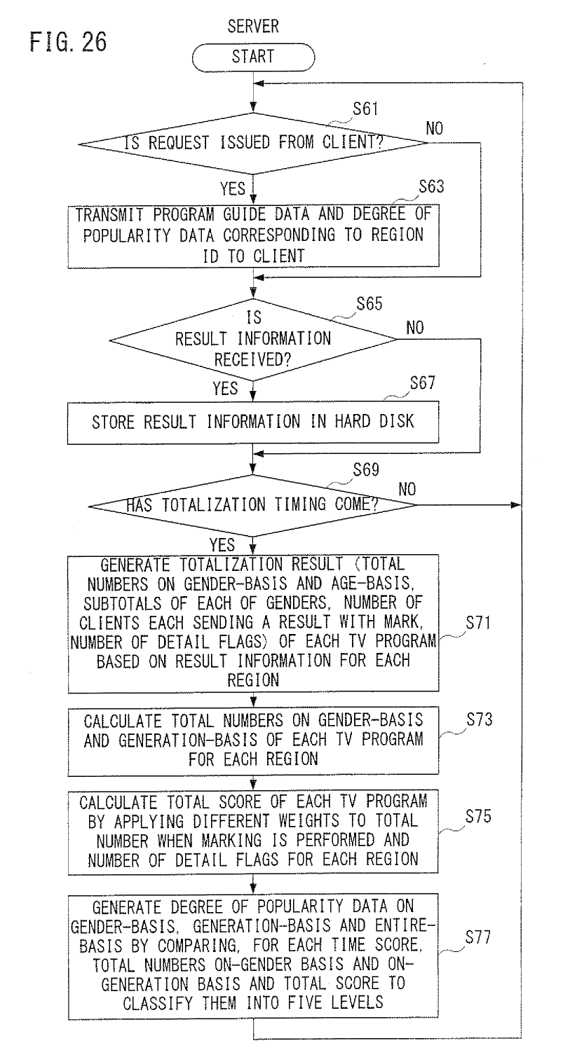

FIG. 26 shows one example of an operation of the distribution server 102. The computer (CPU) of the distribution server 102 determines whether or not a request is issued from the client in a step S61. More specifically, it is determined whether or not request data from the game apparatus 12 is received.

If “YES” in the step S61, the CPU of the distribution server 102 transmits program guide data and degree of popularity data corresponding to the region ID to the client in a step S63. More specifically, the CPU of the distribution server 102 extracts the region ID from the request data from the game apparatus 12, reads the program guide data and the degree of popularity data corresponding to the region ID from the HDD or the memory area 652 and the memory area 656, and transmits them to the game apparatus 12. Here, as program guide data to be distributed, program information by a fixed period of time (one week's programs, for example) including the current date is read from the program guide data. Furthermore, if “NO” in the step S61, the process directly proceeds to a step S65.

In the step S65, the CPU of the distribution server 102 determines whether or not the result information is received from the game apparatus 12. The result information shown in FIG. 10 is transmitted from the game apparatus 12 on which a selecting operation of a program is performed, and it is determined whether or not result information is received here.

If “YES” in the step S65, the CPU of the distribution server 102 stores the received result information in the memory area 654, and stores the result information in the HDD. Additionally, if the result information with the same transmission source ID has already been stored, the stored data is updated to the received result information. Furthermore, if “NO” in the step S65, the process proceeds to a step S69 as it is.

In the step S69, the CPU of the distribution server 102 determines whether or not a totalization timing has come. The totalization timing is set as necessary. For example, if totalization is performed at fixed-time intervals, it is determined whether or not a fixed time elapses from the previous totalization. Furthermore, a predetermined hour of day may be set as a totalization timing.

If “YES” in the step S69, the CPU of the distribution server 102 generates a totalization result of each program for each region on the basis of the result information in a step S71. More specifically, as shown in the upper side of FIG. 17, total numbers on a gender-basis and on an age-basis, a subtotal of each genders, the number of clients who send a result with mark, the number of detail flags, etc. are totalized for each region.

Furthermore, in a step S73, the CPU of the distribution server 102 calculates total numbers on a gender-basis and a generation-basis of each program for each region. More specifically, as shown in FIG. 17, the total numbers on a gender-basis and an age-basis are accumulated so as to become the total numbers on a gender-basis and a generation-basis.

In addition, in a step S75, the CPU of the distribution server 102 calculates a total score of each program for each region by applying different weights to the total number when a marking is made on each program, and the number of detail flags. For example, in the calculation of the total score in FIG. 17, the weight applied to the total number when a marking is made is 10, and the weight applied when the detailed information is merely watched is set to 1.

Succeedingly, in a step S77, the CPU of the distribution server 102 generates degree of popularity data on a gender-basis and a generation-basis and total degree of popularity data by comparing the total number on a gender-basis and a generation-basis of each program for each time slot to classify them into five levels or stages. More specifically, by comparison for each slot as shown in FIG. 18, each of the ranges of five stages of the degree of popularity is set for each gender and for each generation, and depending on which range the count value of each program is included in, a level of the degree of popularity of each program is decided for each gender and for each generation, so that the degree of popularity data for each time slot is generated as shown in FIG. 19. The degree of popularity data is generated by being brought into correspondence to a region ID in the memory area 656 so as to be stored in the HDD. When the process in the step S77 is ended, or if “NO” in the step S69, the process returns to the step S61.

In the above-described embodiment, the distribution server 102 totalizes the result information of the respective game apparatuses 12 to calculate the degree of popularity of the respective programs, and distributes it to the respective game apparatuses 12, but the electronic program guide displaying system 100, as a whole, may have a function of executing processing in relation to the degree of popularity, such as totalization results, calculating a degree of popularity and distributing the degree of popularity, etc. Thus, in another embodiment, the aforementioned process in relation to the degree of popularity may not be constructed so as to be performed in only the distribution server 102. For example, a specific game apparatus 12 may perform the aforementioned process in relation to the degree of popularity, and the aforementioned process in relation to the degree of popularity may be executed by the distributed processing by a plurality of game apparatuses 12. If such the processing is performed, the electronic program guide displaying system 100 may be constructed without including the distribution server 102.

Furthermore, in each of the above-described embodiments, selection results of a number of users are totalized to calculate a degree of popularity. However, in another embodiment, from selection results from a specific group like friends, for example, a degree of popularity may be calculated. In such a case, the distribution server 102 may calculate a degree of popularity from only the selection results of the game apparatus 12 of the users belonging to the specific group and distribute the degree of popularity to the game apparatuses 12 of the users. However, since the respective game apparatuses 12 can receive and send data with each other via a network 104, data in relation to the selection result such as result information are received and transmitted between other game apparatuses 12 (game apparatuses 12 of friends) which have already been registered, and each game apparatus 12 may totalize the selection results by regarding a group including the users of the other game apparatuses 12 as a population, and calculate a degree of popularity of each program.

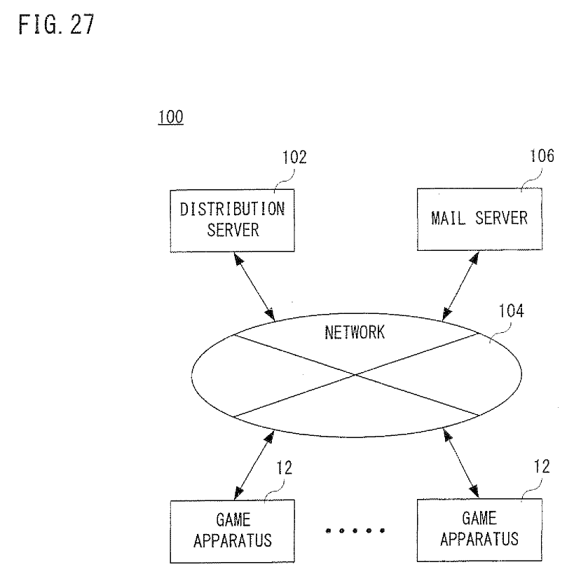

FIG. 27 shows one example of the electronic program guide displaying system 100 of this embodiment. In this embodiment, a game apparatus 12 is constructed so as to transmit and receive data via a mail server 106 on a network 104.

A distribution server 102 distributes program guide data. It should be noted that similar to the above-described embodiment, degree of popularity data targeted to an indefinite number of users may also be distributed. Furthermore, data may be transmitted and received between the distribution server 102 and the game apparatus 12 via the mail server 106.

Each game apparatus 12 transforms data indicative of a selection result by a user (result information in FIG. 10, for example) into an electronic mail format, and transmits and receives the data with other game apparatuses 12 via the network 104 and the mail server 106. Additionally, each of the game apparatuses 12 registers in advance a mail address of a game apparatus 12 of a specific user like friends in an address book memory area provided in the flash memory 44, for example. Furthermore, each of the game apparatuses 12 may only receive data from the game apparatus with the mail address which has already been registered in the address book. Or, if data which has not been registered in the mail address is received, each of the game apparatuses 12 may discard it.

When receiving selection result information from another game apparatus 12 via the mail server 106, each game apparatus 12 performs totalizing processing similar to that in the distribution server 102 of the above-described embodiment to thereby calculate a degree of popularity of each program among the group of the specific users like friends.

In this embodiment, more versatile data in an e-mail format is transmitted and received with the mail server 106, but the format of the data is not restricted to the electronic mail, and can employ various formats. If a communication is restricted among the game apparatuses 12, the format of the data need not take a versatile format. Even if a communication is performed with other terminals (personal computer, cellular phone, hand-held information terminal, etc.), if the data is a versatile format allowing for processing in the terminal, this can be applied. Furthermore, the server may be servers other than the mail server if only the server has a property of reserving transmitted data until an access from a terminal.

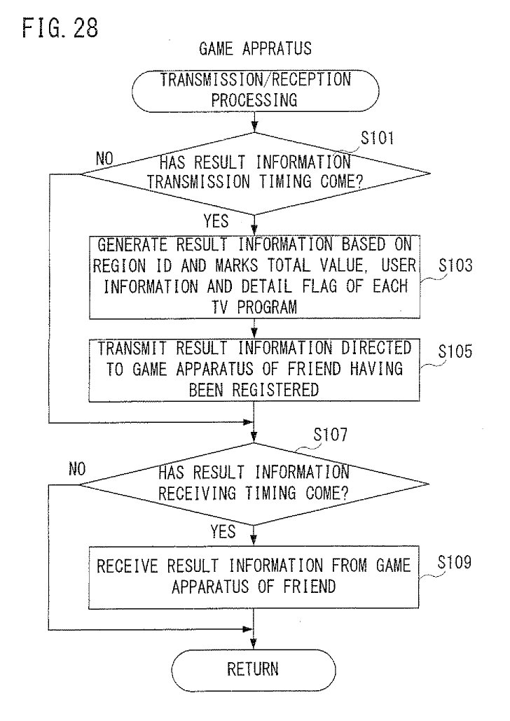

FIG. 28 shows one example of an operation of transmission/reception processing of the game apparatus 12. Additionally, the transmission/reception processing may be executed in place of the step S25-S29 in FIG. 24 in the above-described embodiment.

The CPU 40 determines whether or not a result information transmission timing has come similar to the step S25 in FIG. 24 in a step S101. If “YES” in the step S101, the CPU 40 generates result information in the memory area 514 from a region ID and a mark total value, user information, and a detail flag of each program similar to the step S27 in FIG. 24 in a step S103.

Then, in a step S105, the CPU 40 transmits the result information directed to the address of another game apparatus 12 (that is, game apparatus 12 of a friend) which has been registered in the address book via the input-output processor 42a, the radio communication module 50, etc. More specifically, the result information is transformed into an electronic mail format directed to the friend's game apparatus 12, and transmitted to the mail server 106. Alternatively, if “NO” in the step S101, the process directly proceeds to the step S107.

In the step S107, the CPU 40 determines whether or not a result information receiving timing has come. The result information receiving timing is set as necessary. For example, if a reception of the result information is performed at fixed time intervals, it is determined whether or not a fixed time elapses from the previous receiving processing. Furthermore, the reception timing may be set at a predetermined hour of day or a time when the program guide application is to be started or ended.

If “YES” in the step S107, the CPU 40 receives result information from a friend's game apparatus 12 in a step S109. More specifically, the CPU 40 transmits to the mail server 106 a data request directed to the game apparatus 12, receives, if the data is received by the mail server 106, that is, if the result information directed to its own game apparatus is transmitted from another game apparatus 12, the data from the mail server 106, and stores it in a buffer area, etc. of the external memory 46. It should be noted that the received result information is stored in the flash memory 44 together with the result information generated in the game apparatus 12 until a totalization timing has come. On the other hand, if “NO” in the step S107, the transmission/reception processing is ended as it is.

In addition, the transmission and reception of the result information is executed when the program guide application is executed. However, in another embodiment, the transmission and reception of the result information may be executed when the program guide application is not executed (in the above-described standby mode, for example). In such a case, it may be configured that a task of defining execution of the transmission/reception processing by the CPU 40 at a predetermined schedule during execution of the program guide application is registered in the flash memory 44, and the input-output processor 42a executes the task in the standby mode. Additionally, transmission data directed to the friend's game apparatus 12 may be registered in the flash memory 44 together with the task. When the result information directed to it's own game apparatus is received from the mail server 106 during execution of the task, the input-output processor 42a stores the received data in the flash memory 44.

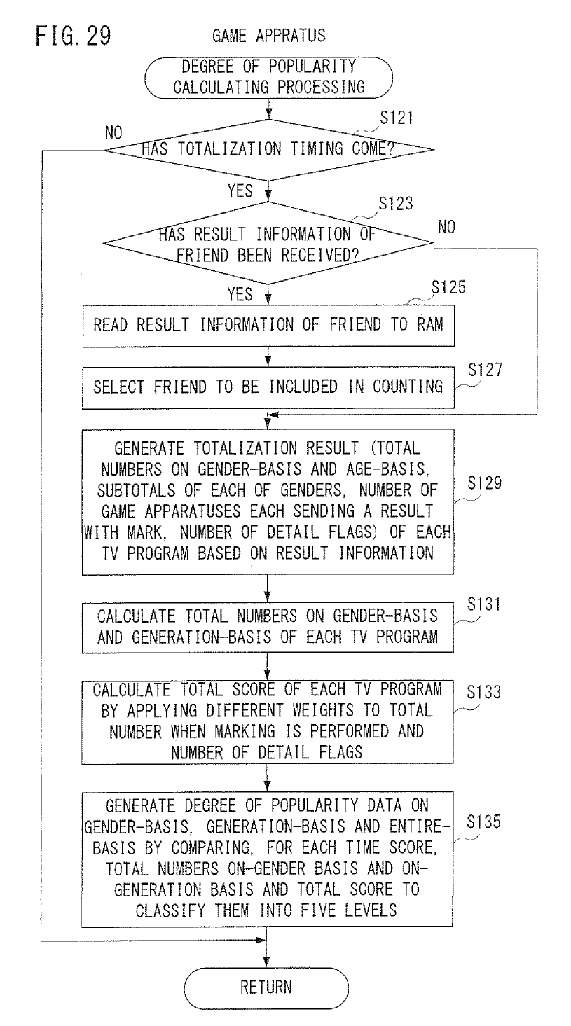

FIG. 29 shows one example an operation of degree of popularity calculating processing in the game apparatus 12. Here, the degree of popularity calculating processing may be executed before the step S33 in FIG. 25 in the above-described embodiment, for example.

In a step S121, the CPU 40 determines whether or not a totalization timing has come. The totalization timing may be set as appropriate. For example, if the totalization is performed at fixed-time intervals, it is determined whether or not a fixed time elapses from the previous totalization timing. Furthermore, a start-up time of the program guide application, a predetermined hour of day, etc. may be set as a totalization timing.

If “YES” in the step S121, the CPU 40 determines whether or not the result information of a friend is received in a step S123. More specifically, it is determined whether or not the result information from the friend's game apparatus 12 is stored in the flash memory 44 or a buffer area of the external memory 46, or the like.

If “YES” in the step S123, the CPU 40 reads the friend's result information to the memory area 514 of the RAM (external memory 46) in a step S125.

In a succeeding step S127, the CPU 40 selects the result information to be included in the totalization out of the received result information. More specifically, if program guide data being different from region to region is distributed from the distribution server 102, the result information having the region ID the same as that of the game apparatus 12 is selected.

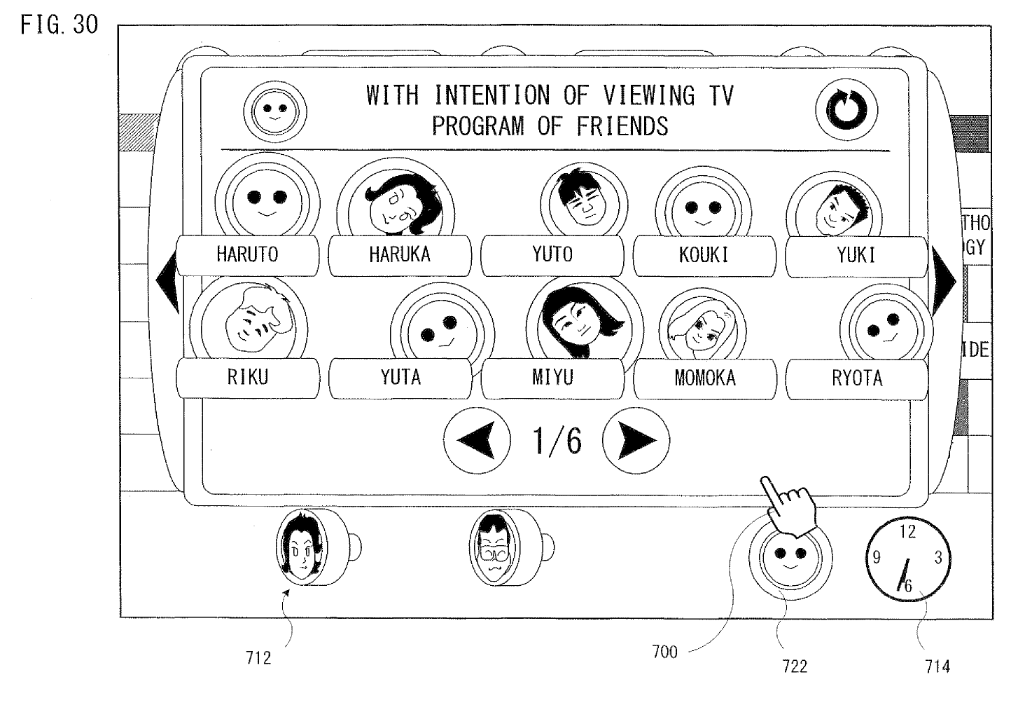

Furthermore, in the initial setting, setting by the button 708, or the like, a friend to be included in the totalization has already been selected from the registered friends by an input by the user, and the result information to be included in the totalization may be selected from the received result information on the basis of the set information. In such a case, a friend list screen as shown in FIG. 30 is displayed on the monitor 34. On the screen, the users of the other registered game apparatuses 12 are displayed. On the screen, the friend to be added to totalized is selected by an input by the user. This makes it possible for the user to calculate a degree of popularity by selecting only the friend whom the user is interested in. Here, if it is allowed to select the user being a friend to be added to the totalization as in this embodiment, the user ID of a user who performs marking is required to be included in the result information to be transmitted. In addition, by fetching a name and mark data which are brought into correspondence with a user ID of a friend from the result information or other data, it is possible to display the friend's name and mark on the friend list screen as shown in FIG. 30.

On the other hand, if “NO” in the step S123, the process directly proceeds to a step S129. In a case that the result information of a friend is not received, a degree of popularity is calculated only from the result information of the users which have already been registered in the game apparatus 12.

In this embodiment, a degree of popularity as a group including the user of the game apparatus 12 and the users of the friend's game apparatuses 12 is calculated and displayed, but degree of popularities may be calculated and displayed by regarding them as separate groups.

From the processing in following steps S129 to S135, totalization and calculation of the degree of popularity are executed. The processing of the steps S129, S131, S133 and S135 are basically similar to the processing in the steps S71, S73, S75 and S77, respectively, in the distribution server 102 of the above-described embodiment in FIG. 26.

That is, in the step S129, the CPU 40 generates a totalization result of each program on the basis of the result information. More specifically, as shown in the upper side of FIG. 17, total numbers on a gender-basis and on an age-basis, subtotals of the respective genders, the number of clients each sending a result with mark, the number of detail flags, etc. are totalized for each region.

The CPU 40 calculates total numbers on a gender-basis and a generation-basis of each program in the succeeding step S131, and calculates a total score of each program by applying different weights to the total number when a marking is performed and to the number of detail flags in the step S133 (see FIG. 17).

Then, in the step S135, the CPU 40 generates degree of popularity data on a gender-basis, a generation-basis and an entire basis by comparing the total numbers and the total scores on a gender-basis and a generation-basis of the respective programs for each time slot to classify them into five levels or stages (see FIG. 18 and FIG. 19). The generated degree of popularity data is stored in the memory area 510 and the flash memory 44. Alternatively if “NO” in the step S121, the degree of popularity calculating processing is ended as it is.

Accordingly, it becomes possible to display the degree of popularity of a specific group including the friends and/or family members who have already been registered in the program guide in this embodiment.

Furthermore, in each of the above-described embodiments, the degree of popularity of each program is divided in to the plurality of stages on the basis of the totalized value of each program. However, in another embodiment, by using the calculated numerical value itself as a degree of popularity, each game apparatus 12 may change a display manner of each program on the basis of the degree of popularity. For example, if a color density and/or a height are changed as a display manner, the color density and/or height may be calculated according to a predetermined relational expression on the basis of the numerical value of the degree of popularity.

In addition, in each of the above-described embodiments, a case that the display system of the invention is applied to the display of a degree of popularity of each program information on the electronic program guide is explained. However, the display system can be applied to the display of a degree of popularity of matters (selection object) to be selected by the user such as various contents and items without being restricted to display of a degree of popularity targeted to the program information. The display system does not display merely higher-ranked programs in a separate table and does not display an order of popularity and a degree of popularity by numeric, but changes a display manner of each selection object depending on the degree of popularity in the list on which a plurality of selection objects are displayed. This makes it possible for the user to intuitively and easily grasp the degree of popularity. For example, the display system can be applied to a system in which titles of a plurality of game software before sale and/or after sale are displayed in list format to accept a popularity votes from users. Alternatively, in a product purchase system in which a plurality of products are displayed to allow the user to purchase a desired product by a user's selecting operation, the present invention can be applied to a system of totalizing the number of users who purchase a product for each product and calculating the degree of popularity. By the display manner of each content like game software, product, etc., the degree of popularity can be represented, allowing the user to intuitively and easily grasp a degree of popularity of each content. Furthermore, the respective contents may simply be aligned in alphabetical order or in an order of release dates, etc., but if the respective contents are displayed in a matrix manner or in a map regarding one axis as genres and the other axis as price ranges, it is possible to easily grasp a trend such as which genre and price range popular contents flock toward. In addition, similar to each of the above-described embodiments, plurality kinds of selecting operations of each content are provided, and different weights may be applied depending on the kind of the selecting operation when the degree of popularity is calculated. For example, in a system in which a popularity vote of game software is accepted, two or more kinds of options like “interesting” and “so interesting” are provided, and different weights may be set to the respective options. Additionally, in a product purchase system, different weights may be applied depending on how many products the user buys. Moreover, the degree of popularity of each content can be calculated for each kind, such as for each regional information, each time slots (release date and time, etc.), each private information on a user, etc. as explained in the above-described embodiment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic program guide displaying system including a plurality of user terminals each having a display to display a plurality of program information in a matrix manner by regarding one axis as a time axis and the other axis as a broadcast station axis, and a server to perform a data communication with said plurality of user terminals via a network, wherein
each of said user terminals comprising:
an accepting means for accepting a selecting operation to select desired program information out of said plurality of program information;
a first transmitting means for transmitting a result of the selecting operation accepted by said accepting means to said server;
a first receiving means for receiving degree of popularity data of each of said program information from said server; and
a display manner changing means for changing a display manner of each program information displayed in a matrix on the basis of said degree of popularity data,
said server comprising:
a second receiving means for receiving a result of said selecting operation from each of said user terminals;
a degree of popularity calculating means for calculating degree of popularity data indicating a degree of popularity of each of said plurality of program information on the basis of the result of said selecting operation; and
a second transmitting means for transmitting said degree of popularity data calculated by said degree of popularity calculating means to each of said user terminals.

2. An electronic program guide displaying system according to claim 1, wherein said degree of popularity calculating means classifies said plurality of program information into a plurality of levels on the basis of the result of said selecting operation, and calculates said degree of popularity data indicating said level of each of said program information, and
said display manner changing means changes each of said program information into a display manner set in advance for each level.

3. An electronic program guide displaying system according to claim 1, wherein
said accepting means accepts at least one selecting operation out of a first selecting operation to set said desired program information to a first state and a second selecting operation to set said desired program information to a second state, and
said degree of popularity calculating means calculates said degree of popularity data by applying different weights between said first selecting operation and said second selecting operation.

4. An electronic program guide displaying system according to claim 2, wherein
said accepting means accepts at least one selecting operation out of a first selecting operation to set said desired program information to a first state and a second selecting operation to set said desired program information to a second state, and
said degree of popularity calculating means calculates said degree of popularity data by applying different weights between said first selecting operation and said second selecting operation.

5. An electronic program guide displaying system according to claim 1, wherein
said display manner changing means changes a density of a display color of each of said program information on the basis of said degree of popularity data.

6. An electronic program guide displaying system according to claim 2, wherein
said display manner changing means changes a density of a display color of each of said program information on the basis of said degree of popularity data.

7. An electronic program guide displaying system according to claim 1, wherein
each of said user terminals displays said plurality of program information displayed in a matrix manner by a 3-D image, and
said display manner changing means changes a height of each of said program information on the basis of said degree of popularity data.

8. An electronic program guide displaying system according to claim 2, wherein
each of said user terminals displays said plurality of program information displayed in a matrix manner by a 3-D image, and
said display manner changing means changes a height of each of said program information on the basis of said degree of popularity data.

9. An electronic program guide displaying system according to claim 1, wherein
each of said user terminals further comprises a private information inputting means for inputting private information of each user,
said first transmitting means transmits said private information in addition to the result of said selecting operation to said server,
said degree of popularity calculating means calculates said degree of popularity data indicating a degree of popularity of each of said program information for each kind of said private information on the basis of the result of said selecting operation and said private information, and
said display manner changing means changes the display manner of each of said program information on the basis of said degree of popularity data corresponding to the selected kind.

10. An electronic program guide displaying system according to claim 2, wherein
each of said user terminals further includes a private information inputting means for inputting private information of each user,
a first transmitting means transmits said private information in addition to said selecting operation to said server,
said degree of popularity calculating means calculates said degree of popularity data indicating a degree of popularity of each of said program information for each kind of said private information on the basis of the result of said selecting operation and said private information, and
said display manner changing means changes the display manner of each of said program information on the basis of said degree of popularity data corresponding to the selected kind.

11. An electronic program guide displaying system according to claim 1, wherein
said degree of popularity calculating means compares said respective program information for each time slot with a predetermined range on the basis of the result of said selecting operation, and calculates said degree of popularity data indicating a degree of popularity of said respective program information in each time slot on the basis of said comparison result.

12. An electronic program guide displaying system according to claim 2, wherein
said degree of popularity calculating means compares said respective program information for each time slot with a predetermined range on the basis of the result of said selecting operation, and calculates said degree of popularity data indicating a degree of popularity of said respective program information in each time slot on the basis of said comparison result.

13. An electronic program guide displaying system according to claim 1, wherein
said first transmitting means transmits regional information in addition to the result of said selecting operation to said server,
said degree of popularity calculating means calculates said degree of popularity data indicating a degree of popularity of each of said program information for each region on the basis of the result of said selecting operation and said regional information, and
said second transmitting means transmits said degree of popularity data corresponding to said regional information transmitted by said first transmitting means to each of said user terminals.

14. An electronic program guide displaying system according to claim 2, wherein
said first transmitting means transmits regional information in addition to the result of said selecting operation to said server,
said degree of popularity calculating means calculates said degree of popularity data indicating a degree of popularity of each of said program information for each region on the basis of the result of said selecting operation and said regional information, and
said second transmitting means transmits said degree of popularity data corresponding to said regional information transmitted by said first transmitting means to each of said user terminals.

15. An electronic program guide displaying system to display a plurality of program information in a matrix manner by regarding one axis as a time axis and the other as a broadcast station axis, comprising:
an accepting means for accepting a selecting operation to select desired program information out of said plurality of program information from a plurality of users,
a degree of popularity calculating means for calculating degree of popularity data indicating a degree of popularity of each of said plurality of program information on the basis of the result of the selecting operation accepted by said accepting means, and
a display manner changing means for changing the display manner of each of said program information displayed in said matrix on the basis of said degree of popularity data calculated by said degree of popularity calculating means.

16. A user terminal which is utilized in an electronic program guide display system, performs a data communication with a server via a network, and has a display displaying a plurality of program information in a matrix manner by regarding one axis as a time axis and the other axis as a broadcast station axis, comprising:
an accepting means for accepting a selecting operation to select desired program information from said plurality of program information,
a first transmitting means for transmitting the result of the selecting operation accepted by said accepting means to said server,
a first receiving means for receiving the degree of popularity data of each of said program information calculated on the basis of the result of said selecting operation from said server, and
a display manner changing means for changing the display manner of each program information displayed in a matrix on the basis of said degree of popularity data.

17. A storage medium storing a program to be executed by a computer of a user terminal which is utilized in an electronic program guide display system, performs a data communication with a server via a network, and has a display displaying a plurality of program information in a matrix manner by regarding one axis as a time axis and the other axis as a broadcast station axis, wherein
said program causes said computer to execute
an accepting step for accepting a selecting operation to select desired program information from said plurality of program information,
a first transmitting step for transmitting the result of the selecting operation accepted by said accepting step to said server,
a first receiving step for receiving the degree of popularity data of each of said program information calculated on the basis of the result of said selecting operation from said server, and
a display manner changing step for changing a display manner of each program information displayed in said matrix on the basis of said degree of popularity data.

18. A server which is used in an electronic program guide displaying system, and performs a data communication via a network with a plurality of user terminals each having a display displaying a plurality of program information in a matrix manner by regarding one axis as a time axis and the other axis as a broadcast station axis, comprising:
a second receiving means for receiving from each of said user terminal the result of the selecting operation which is accepted by each of said user terminal and is for selecting desired program information out of said plurality of program information;
a degree of popularity calculating means for calculating degree of popularity data to change, on the basis of the result of said selecting operation, the display manner of each program information which indicates a degree of popularity of each of said plurality of program information and displayed in a matrix manner in each of said user terminal; and
a second transmitting means for transmitting said degree of popularity data calculated by said degree of popularity calculating means to each of said user terminal.

19. A storage medium storing a program to be executed by a computer of a server which performs a data communication via a network with a plurality of user terminals which are used in an electronic program guide displaying system and each has a display displaying a plurality of program information in a matrix manner by regarding one axis as a time axis and the other axis as a broadcast station axis, wherein
said program causes the computer to execute:
a second receiving step for receiving from each of said user terminal the result of the selecting operation which is accepted by each of said user terminal and is for selecting desired program information out of said plurality of program information;
a degree of popularity calculating step for calculating degree of popularity data to change, on the basis of the result of said selecting operation, the display manner of each program information which indicates a degree of popularity of each of said plurality of program information and displayed in a matrix manner in each of said user terminal; and
a second transmitting step for transmitting said degree of popularity data calculated by said degree of popularity calculating step to each of said user terminal.

20. A display system to display a plurality of selection objects, comprising:
an accepting means for accepting a selecting operation to select a desired selection object out of said plurality of selection objects from a plurality of users;
a degree of popularity calculating means for calculating degree of popularity data indicating a degree of popularity of each of said plurality of selection objects on the basis of the result of the selecting operation accepted by said accepting means; and
a display manner changing means for changing a display manner of each of said selection objects on the basis of said degree of popularity data calculated by said degree of popularity calculating means.
